(19) United States
(12) Patent Application Publication
(10) Pub. No.: US 2020/0195791 A1
(43) Pub. Date: Jun. 18, 2020

(54) IMAGE PROCESSING SYSTEM, CLOUD SERVER, AND PROGRAM

(71) Applicant: KONICA MINOLTA, INC., Tokyo (JP)

(72) Inventor: Kazuya TAKAHASHI, Itami-shi (JP)

(73) Assignee: KONICA MINOLTA, INC., Tokyo (JP)

(21) Appl. No.: 16/691,361

(22) Filed: Nov. 21, 2019

(30) Foreign Application Priority Data
Dec. 12, 2018 (JP) 2018-232901

(51) Int. Cl. H04N 1/00

(52) U.S. Cl. CPC H04N 1/0097; H04N 1/00244; H04N 2201/0094; H04N 1/00482; H04N 1/00403; H04N 1/00973

(57) ABSTRACT

An image processing system includes an image processing apparatus and a cloud server, wherein the cloud server includes: an acquirer that acquires a user instruction relating to the setting process in the image processing apparatus from the external device; a first storage that stores settings information about the image processing apparatus, the settings information being based on the user instruction; a determiner that determines whether the cooperation process is being continued; and a transmitter that transmits the settings information to the image processing apparatus, and the image processing apparatus includes: a second storage that stores the settings information transmitted from the cloud server, a setter that performs the setting process in the image processing apparatus, on a basis of the settings information; and a resetter that resets the settings information stored in the second storage, in response to elapse of a predetermined non-instruction period.

The entire disclosure of Japanese patent Application No. 2018-232901, filed on Dec. 12, 2018, is incorporated herein by reference in its entirety.

### BACKGROUND

### Technological Field

The present invention relates to an image processing system including an image processing apparatus such as multi-function peripherals (MFP), and related technologies.

### Description of the Related Art

Some MFPs have a function (also called an automatic reset function) of automatically resetting settings contents that have been set through an operation panel, in a case where any operation has not been performed on the operation panel over a certain period of time (see JP 2014-236417 A). Such an automatic reset function is particularly useful in a case where an MFP is shared by a plurality of users, for example.

Further, there is a technology for operating a target apparatus by issuing a user instruction (a voice instruction) using an audio device such as a smart speaker (an AI speaker). More specifically, voice data that has been input to an audio device is transmitted to a cloud server, and a natural language analyzing process for the voice data is performed by the cloud server, to identify the contents of the user instruction. Such a technology (a natural language analyzing process or the like by a cloud server) is applied so that an MFP can be operated by voice. For example, various kinds of settings (such as “two copies” and “two-side printing”) in a copy job to be executed by an MFP can be designated by voice.

In a case where an MFP setting process is performed with an audio device, the above described automatic reset function is preferably modified as follows. Specifically, in a case where any user instruction from an audio device via a cloud server is not transmitted to the MFP over a certain period of time (50 seconds, for example), it is determined that a predetermined non-instruction period has elapsed, and the settings contents of the MFP are reset.

However, in a case where such a modification is made, the process only between the audio device and the cloud server takes a relatively long time. In other words, any instruction to the MFP might not be issued over a relatively long period of time (70 seconds, for example). For example, in a case where the audio device reads out all the settings contents transferred from the cloud server to the audio device to check the contents of an instruction from the user, the non-instruction period that is a relatively long period is likely to elapse.

In such a case, it is determined that any instruction from the cloud server to the MFP has not been issued over a certain period of time (or the predetermined non-instruction period has passed), though the cooperation process among the audio device, the cloud server, and the MFP is actually being continued. As a result, the MFP resets the settings contents stored therein. In such a situation, it takes a lot of trouble for the user to perform the setting again from the beginning.

### SUMMARY

Therefore, an object of the present invention is to provide a technique that does not require the user to perform the setting again from the beginning even in a case where the settings contents are reset in response to the elapse of the non-instruction period in the image processing apparatus.

To achieve the abovementioned object, according to an aspect of the present invention, an image processing system reflecting one aspect of the present invention comprises an image processing apparatus and a cloud server, the image processing system being capable of performing a setting process in the image processing apparatus through a cooperation process among the image processing apparatus, the cloud server, and an external device, wherein the cloud server includes: an acquirer that acquires a user instruction relating to the setting process in the image processing apparatus from the external device, a first storage that stores settings information about the image processing apparatus, the settings information being based on the user instruction; a determiner that determines whether the cooperation process is being continued; and a transmitter that transmits the settings information to the image processing apparatus, the image processing apparatus includes: a second storage that stores the settings information transmitted from the cloud server; a setter that performs the setting process in the image processing apparatus, on a basis of the settings information; and a rescuer that resets the settings information stored in the second storage, in response to elapse of a predetermined non-instruction period, and, when it is determined that the cooperation process is being continued after the settings information stored in the second storage is reset in response to elapse of the predetermined non-instruction period, the image processing system performs the setting process in the image processing apparatus, on a basis of the settings information stored in the first storage of the cloud server.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a schematic diagram showing the configuration of an image processing system according to a first embodiment;

FIG. 2 is a diagram showing the functional blocks of an MFP;

FIG. 3 is a diagram showing the functional blocks of a cloud server;

FIG. 4 is a conceptual diagram showing an outline of operation according to the first embodiment;

FIG. 5 is a table showing a settings database;

FIG. 6 is a diagram showing an initial setting screen relating to a copy job;

FIG. 7 is a diagram showing the setting screen in which the set value of a setting item “number of copies” has been changed;

FIG. 8 is a diagram showing the setting screen in which the set value of a setting item “print output type” has been changed;

FIG. 9 is a diagram showing the setting screen in which the set value of a setting item “color selection” has been changed;

FIG. 10 is a flowchart showing an operation of the cloud server;

FIG. 11 is a flowchart showing an operation of the cloud server;

FIG. 12 is a flowchart showing an operation of an MFP;

FIG. 13 is a timing chart showing an example operation in the image processing system;

FIG. 14 is a timing chart showing an example operation in the image processing system;

FIG. 15 is a conceptual diagram showing an outline of operation according to a second embodiment;

FIG. 16 is a diagram showing the functional blocks of an MFP according to the second embodiment;

FIG. 17 is a flowchart showing operation of an MFP immediately after a restart of a voice application;

FIG. 18 is a timing chart showing part of an example operation according to the second embodiment;

FIG. 19 is a timing chart showing another example operation;

FIG. 20 is a flowchart showing operation of an MFP according to a third embodiment;

FIG. 21 is a flowchart showing operation of a cloud server according to the third embodiment;

FIG. 22 is a flowchart showing operation of the cloud server according to the third embodiment;

FIG. 23 is a timing chart showing an example operation in an image processing system according to the third embodiment;

FIG. 24 is a timing chart showing an example operation in the image processing system according to the third embodiment;

FIG. 25 is a timing chart showing an example operation in the image processing system according to the third embodiment; and

FIG. 26 is a timing chart showing another example operation according to the third embodiment.

### DETAILED DESCRIPTION OF EMBODIMENTS

Hereinafter, one or more embodiments of the present invention will be described with reference to the drawings. However, the scope of the invention is not limited to the disclosed embodiments.

### 1. First Embodiment

### 1-1. System Configuration

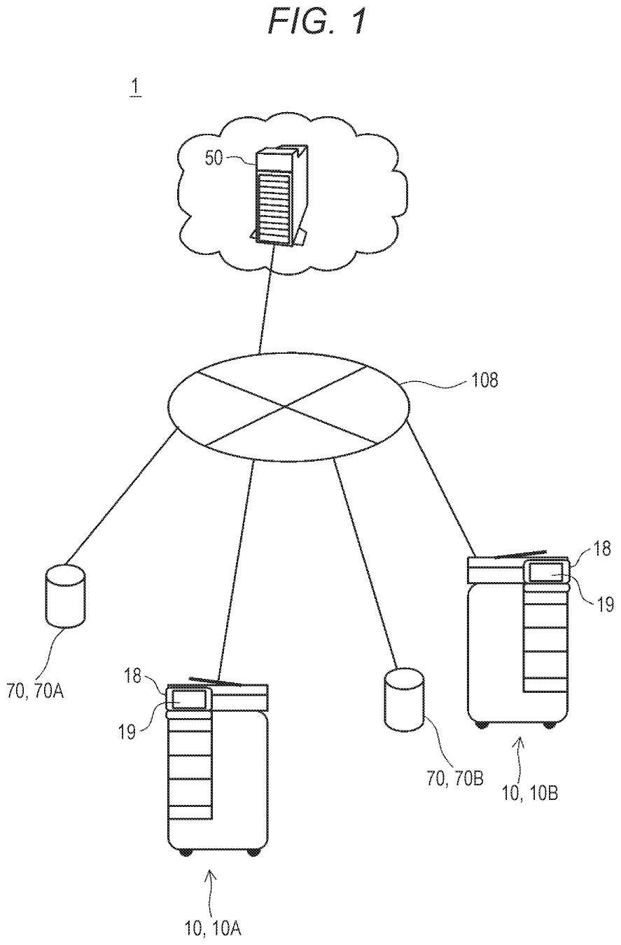

FIG. 1 is a schematic diagram showing the configuration of an image processing system 1 according to a first embodiment of the present invention. As shown in FIG. 1, the image processing system 1 includes a server computer (specifically, a cloud server) 50, a plurality of MFPs 10 (10A, 10B, . . . ), and a plurality of audio devices 70 (70A, 70B, . . . ).

Each MFP 10 and the cloud server 50 are connected to each other via a network 108. Each audio device 70 and the cloud server 50 are also connected to each other via the network 108. The network 108 is formed with a local area network (LAN), the Internet, or the like. Further, the mode of connection to the network 108 may be wired connection, or may be wireless connection.

Each audio device 70 is a device that includes a speaker (a voice output unit) and a microphone (a voice input unit). This audio device 70 is a so-called smart speaker. The audio device 70 can communicate with the cloud server 50 via the network 108, to exchange voice information and the like with the cloud server 50. The cloud server 50 can receive input voice (input voice data) from the audio device 70, and perform a natural language analyzing process on the voice (the input voice), to receive a user instruction through the input voice. The cloud server 50 can also transmit voice (a responding voice, or specifically, voice data) in response to the user instruction or the like to the audio device 70, to output the response voice (a voice output) via the speaker of the audio device 70.

Next, the MFP 10 and the cloud server 50 are described.

### 1-2. Configuration of an MFP 10

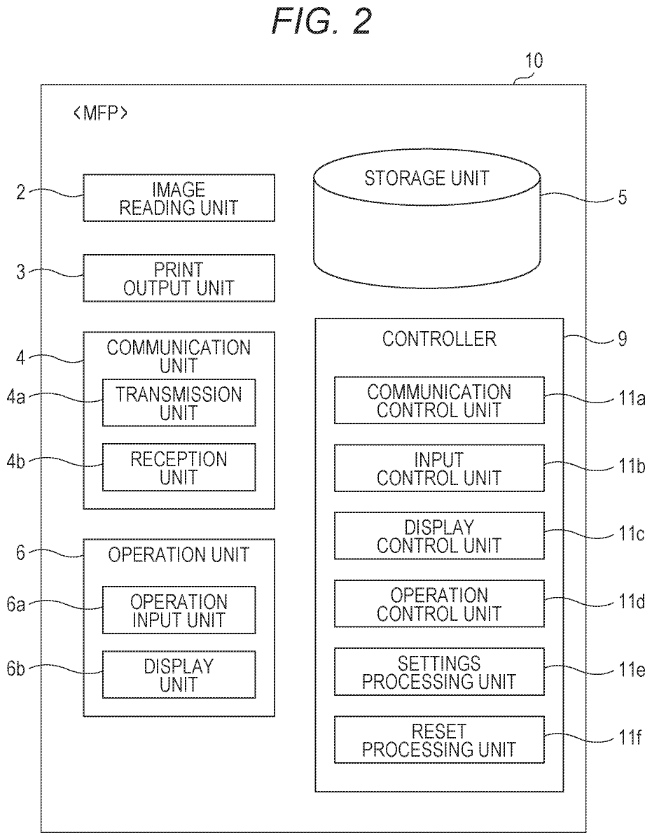

FIG. 2 is a diagram showing the functional blocks of a multi-functional peripheral (MFP) 10.

An MFP 10 is a device (also referred to as a multi-function machine) having a scan function, a copy function, a facsimile function, a box storage function, and the like. Specifically, as shown in the functional block diagram in FIG. 2, the MFP 10 includes an image reading unit 2, a print output unit 3, a communication unit 4, a storage unit 5, an operation unit 6, and a controller 9, and achieves the various functions by causing the respective components to operate in combination. The MFP 10 is also referred to as an image processing apparatus or an image forming apparatus.

The image reading unit 2 is a processing unit that optically reads (or scans) a document placed at a predetermined position on the MFP 10, and generates image data (also referred to as a document image or a scanned image) of the document. The image reading unit 2 is also referred to as a scan unit.

The print output unit 3 is an output unit that prints and outputs images onto various kinds of media, such as paper, in accordance with data relating to the print target. The MFP 10 is also an electrophotographic printer (a full-color printer), and the print output unit 3 has various hardware mechanisms such as an exposure unit, a developing unit, a transfer unit, and a fixing unit.

The communication unit 4 is a processing unit capable of performing facsimile communication via a public line or the like. The communication unit 4 can further perform network communication via the network 108. In the network communication, various kinds of protocols such as TCP/IP (Transmission Control Protocol/Internet Protocol) are used, for example. Using the network communication, the MFP 10 can exchange various kinds of data with a desired communication destination (such as the cloud server 50). The communication unit 4 includes a transmission unit 4a that transmits various kinds of data, and a reception unit 4b that receives various kinds of data.

The storage unit 5 is formed with a storage device such as a semiconductor memory (a RAM or the like) and a hard disk drive (HDD) or the like. The storage unit 5 (a semiconductor memory or the like) of the MFP 10 temporarily stores settings contents (including settings information and the like transmitted from the cloud server 50) relating to the job to be executed in the MFP 10.

The operation unit 6 includes an operation input unit 6a that receives an operation input directed to the MFP 10, and a display unit 6b that displays and outputs various kinds of information. The MFP 10 includes a. plate-like operation panel 18 (see FIG. 1), and the operation panel 18 has a touch panel 19 (see FIG. 1) on its front side. The touch panel 19 has a piezoelectric sensor or the like buried in a liquid crystal display panel, and can display various kinds of information and receive an operation input from an operator. For example, the touch panel 19 displays various kinds of screens (including button images and the like), such as a menu screen. The operator can change the contents of various settings of the MFP 10 by pressing buttons (buttons represented by button images) virtually arranged in the touch panel 19. The touch panel 19 functions as part of the operation input unit 6a, and also functions as part of the display unit 6b.

The controller (control unit) 9 is a control device that is built in the MFP 10, and comprehensively controls the MFP 10. The controller 9 is formed as a computer system that includes a CPU and various kinds of semiconductor memories (a RAM and a ROM). The controller 9 functions as the respective processing units, as the CPU executes a predetermined software program (hereinafter also referred to simply as the program) stored in a ROM (such as an EEPROM (registered trademark)). Note that the program (more specifically, a program module group) may be recorded in a portable recording medium such as a USB memory, be read out from the recording medium, and be installed into the MFP 10. Alternatively, the program may be downloaded via a network or the like, and be installed into the MFP 10.

Here, “voice application software” Q1 (application software for operating the MFP 10 by voice, in cooperation with an audio device 70 or the cloud server 50) is installed as the program in the MFP 10. In other words, application software for cooperating with the cloud server 50 and the MFP 10 (or application software for executing a setting process in the MFP 10 on the basis of the settings information transmitted from the cloud server) is installed in the MFP 10. The “voice application software” (Q1) is also called “voice application” or “voice app”.

Specifically, the controller 9 executes the program, to form various kinds of processing units including a communication control unit 11a, an input control unit 11b, a display control unit 11c, an operation control unit 11d, a settings processing unit 11e, and a reset processing unit 11f, as shown in FIG. 2.

The communication control unit 11a is a processing unit that controls communication operations with other devices (such as the cloud server 50).

The display control unit 11c is a processing unit that controls display operations in the display unit 6b. The display control unit lie causes the display unit 6b to display an operation screen (including a settings screen relating to jobs in the MFP 10) for operating the MFP 10.

The input control unit 11b is a control unit that controls an operation input operation directed to the operation input unit 6a. For example, the input control unit 11b controls an operation for receiving an operation input to the operation screen.

The operation control unit 11d is a control unit that controls a print output operation, a scan operation, a facsimile communication operation, and the like in the MFP 10.

The settings processing unit 11e is a processing unit that performs a setting process relating to the MFP 10 (a setting process and the like relating to jobs in the MFP 10), on the basis of the settings information temporarily stored in the storage unit 5.

The reset processing unit 11f is a processing unit that performs a process of (automatically) resetting (returning to the default values) the settings information temporarily stored in the storage unit 5 in response to the elapse of a predetermined non-instruction period (a non-response period) (this process is also called an automatic reset process).

### 1-3. Configuration of the Cloud Server 50

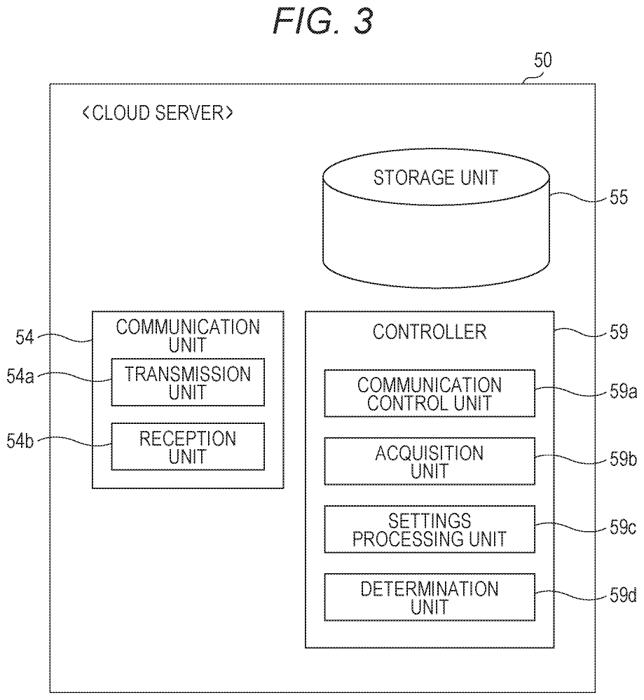

Referring now to FIG. 3, the configuration of the cloud server 50 is described. FIG. 3 is a diagram showing the functional blocks of the cloud server 50.

As shown in the functional block diagram in FIG. 3, the cloud server 50 includes a communication unit 54, a storage unit 55, and a controller 59, and achieves various functions by causing the respective components to operate in combination.

The communication unit 54 can perform network communication via the network 108. In the network communication, various kinds of protocols such as TCP/IP (Transmission Control Protocol/Internet Protocol) are used, for example. Using the network communication, the cloud server 50 can exchange various kinds of data with a desired communication destination (such as an MFP 10 and an audio device 70). The communication unit 54 includes a transmission unit 54a that transmits various kinds of data, and a reception unit 54b that receives various kinds of data.

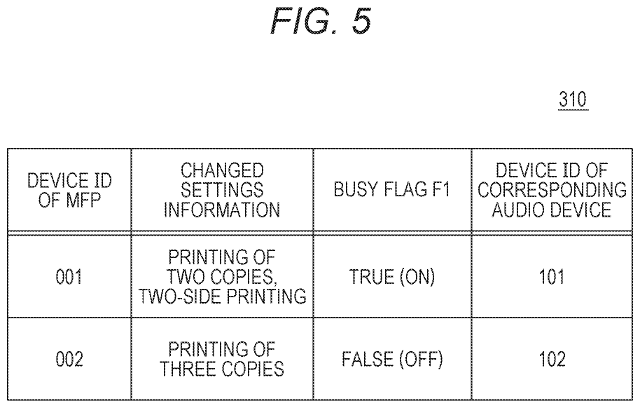

The storage unit 55 is formed with a storage device such as a semiconductor memory (a RAM or the like) and a hard disk drive (HDD) or the like. The storage unit 55 stores settings information (the settings information in an MFP 10) based on a voice instruction (user instruction) received from the audio device 70, and the like. Specifically, a settings database 310 (see FIG. 5) is built in the storage unit 55, and the settings information is updated and registered in the settings database 310 as needed. FIG. 5 is a diagram illustrating an example of the settings database 310.

The controller (control unit) 59 in FIG. 3 is a control device that is built in the cloud server 50, and comprehensively controls the cloud server 50. The controller 59 is formed as a computer system including a CPU and various kinds of semiconductor memories (a RAM and a ROM). The controller 59 forms various kinds of processing units, as the CPU executes a predetermined program (an OS, applications, or the like) stored in a storage unit (a semiconductor memory or the like). Note that the program (more specifically, a program module group) may be recorded in a portable recording medium (such as a CD-ROM or a USB memory), be read out from the recording medium, and be installed into the cloud server 50. Alternatively, the program may be transmitted via a network or the like, and be installed into the cloud server 50.

Here, “MFP cooperating cloud application software” Q5 (application software (an application for servers) for operating an MFP 10 by voice, in cooperation with an audio device 70 and the cloud server 50) is installed as the program. Note that the “MFP cooperating cloud application software” (Q5) is also referred to as an “MFP cooperating cloud application” or an “MFP cooperating cloud app”.

The controller 59 executes the program, to form various kinds of processing units including a communication control unit 59a, an acquisition unit 59b, a settings processing unit 59c, and a determination unit 59d.

The communication control unit 59a is a processing unit that controls communication operations with the MFPs 10 and the audio devices 70, in cooperation with the communication unit 54 and the like.

The acquisition unit 59b is a processing unit that acquires, from an audio device 70, a user voice instruction (a voice instruction relating to an execution target job setting process or the like in the MFP 10) input to the audio device 70.

The settings processing unit 59c is a processing unit that outputs, to the MFPs 10, various kinds of instructions (settings instructions, job execution instructions, and the like) directed to the MFPs 10, in accordance with user instructions acquired by the acquisition unit 59b.

The determination unit 59d is a processing unit that determines whether a cooperation process among an MFP 10, the cloud server 50, and an audio device 70 is being continued. In other words, the determination unit 59d determines whether the setting process relating to an MFP 10 is being continued, using an audio device 70 and the cloud server 50.

### 1-4. Outline of Operation

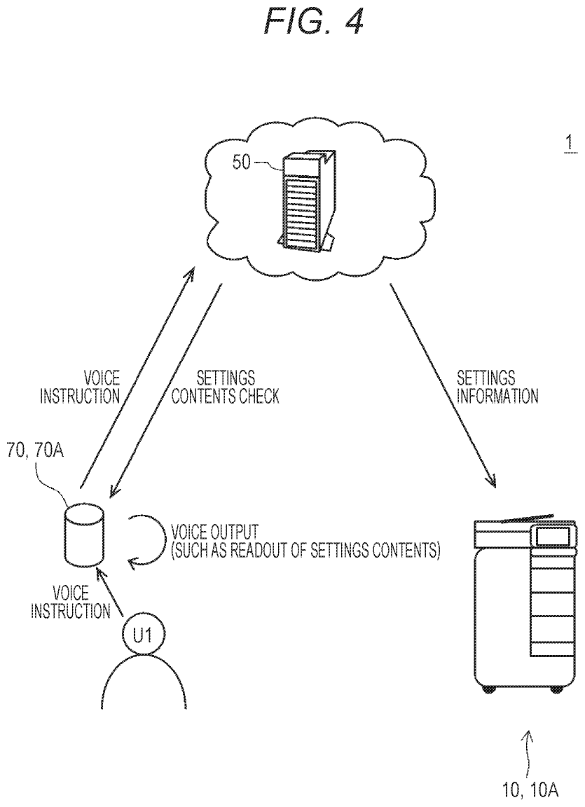

Next, an outline of operation in the system 1 is described with reference to FIG. 4. FIG. 4 is a conceptual diagram showing an outline of operation according to the first embodiment.

In the image processing system 1, a setting process or the like is performed on an MFP 10 through a cooperation process among the MFP 10, the cloud server 50, and an audio device 70. Specifically, a setting process or the like relating to a job in an MFP 10 is performed in accordance with a voice instruction using an audio device 70 (an instruction via the cloud server 50). In this embodiment, the MFP 10 accepts a setting process based on an operation instruction using the operation panel 18 of the MFP 10 (an instruction issued not via the cloud server 50), in addition to a setting process based on a voice instruction using the audio device 70. The description herein focuses on a setting process or the like based on a voice instruction using the audio device 70.

When the audio device 70 receives a voice input by a user (in other words, a user instruction (a voice instruction) input by voice), the audio device 70 transmits the voice (specifically, voice data) to the cloud server 50. On the basis of the voice data from the audio device 70, the cloud server 50 acquires the user instruction (a user instruction regarding a setting process or the like for the MFP 10). Specifically, the cloud server 50 performs a natural language analyzing process or the like on the voice data received from the audio device 70, grasps (understands) the contents of the user's voice instruction, and acquires (identifies) the user instruction,

The cloud server 50 then stores information based on the user instruction (including the settings information or the like relating to the MFP 10) into the storage unit 55 (FIG. 3) in the cloud server 50 (more specifically, into the settings database 310 (FIG. 5)). The cloud server 50 further transmits stored information (the settings information) stored in the storage unit 55 (the settings database 310) to the MFP 10.

The MFP 10 stores the settings information transmitted from the cloud server 50 into the storage unit 5 (FIG. 2) in the MFP 10, and performs a setting process relating to the MFP 10, on the basis of the settings information stored in the storage unit 5 in the MET 10.

Here, the MFP 10 has an “automatic reset function”. Specifically, the MFP 10 resets the settings information stored (temporarily) in the storage unit 5 of the MFP 10 (or returns the set values relating to the respective setting items to the default values (initial values)), in response to the elapse of a predetermined non-instruction period (50 seconds, for example). In this embodiment, during the predetermined non-instruction period, there is no user instruction to the operation panel 18 of the MFP 10 (that is, there is no direct operation instruction based on the user's finger or the like moved on the operation panel 18), and there is no instruction from the cloud server 50 to the MFP 10 (that is, there is no user instruction from any audio device 70).

In the image processing system 1, processing only between the audio device 70 and the cloud server 50 might be performed for a relatively long time during a cooperation process among the three sides 10, 50, and 70 (in other words, any instruction is not issued to the MFP 10 for a relatively long period of time). For example, during a process of reading out the settings contents (a process in which the audio device 70 reads out all the settings contents transferred from the cloud server 50 to the audio device 70, to check the contents of an instruction from the user (a voice output process)), any instruction is transmitted from the cloud server 50 to the MFP 10. Therefore, there is a high possibility that such a relatively long non-instruction period elapses.

In such a case, the MFP 10 determines that the predetermined non-instruction period has elapsed, and resets the settings contents temporarily stored in the storage unit 5 in the MFP 10 (automatic reset).

In such a situation, it takes a lot of trouble for the user to perform the setting again from the beginning.

Therefore, the process described below is performed in this embodiment.

Specifically, every time a voice instruction from the user is issued, the voice instruction is transmitted from the audio device 70 to the cloud server 50, and the cloud server 50 determines whether the cooperation process among the MFP 10, the cloud server 50, and the audio device 70 is being continued, on the basis of a busy flag F1 (see FIG. 5, described later) in the cloud server 50.

In a case where it is determined that the cooperation process is being continued, a setting process for the MFP 10 is performed on the basis of the settings information stored in the storage unit 55 (the settings database 310) of the cloud server 50.

More specifically, in a case where it is determined that the cooperation process is being continued, the cloud server 50 transmits the settings information (the set values relating to all of the setting items in the plurality of setting items designated in advance) stored in the storage unit 55 of the cloud server 50, to the MFP 10. On the basis of the settings information transmitted from the cloud server 50, the MFP 10 sets the settings information that has been set on the basis of a user instruction (a user instruction via the audio device 70 or the like) in the MFP 10. More specifically, the settings information that has been set on the basis of a user instruction is reproduced. in the storage unit 5 of the MFP 10, and a setting process for the MFP 10 is performed on the basis of the reproduced settings information.

In this embodiment, such an operation is performed every time a voice instruction is issued from the user, both before and after execution of an automatic reset.

Particularly, after the MFP 10 performs an automatic reset (specifically, after the settings information stored in the storage unit 5 of the MFP 10 is reset in response to the elapse of the predetermined non-instruction period), the above operation is performed. Executed. Specifically, in a case where it is determined that the cooperation process among the three sides 10, 50, and 70 is being continued, the settings information that has been set on the basis of a user instruction (the settings contents immediately before the automatic reset) is reproduced in the storage unit 5 of the MFP 10, on the basis of the settings information stored in the storage unit 55 of the cloud server 50. Accordingly, even in a case where the settings contents are reset in response to the elapse of the non-instruction period during which no instructions have been issued from the cloud server 50 (that is, after execution of the automatic reset), settings information reflecting the user instruction is automatically reproduced in the storage unit 5 of the MFP 10, on the basis of the settings information stored in the storage unit 55 of the cloud server 50. Thus, even after an automatic reset occurs, the user does not need to perform the setting again from the beginning

### 1-5. Specific Operations

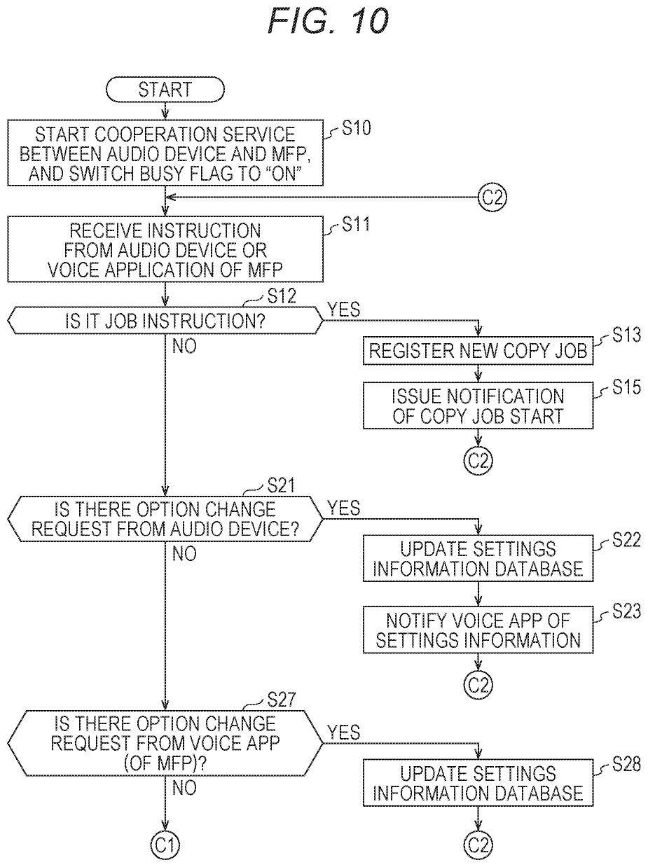

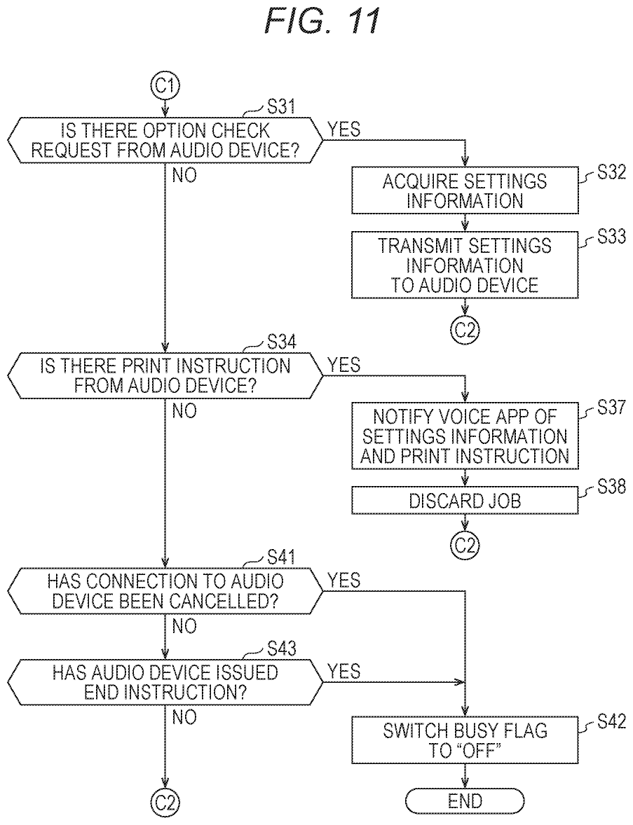

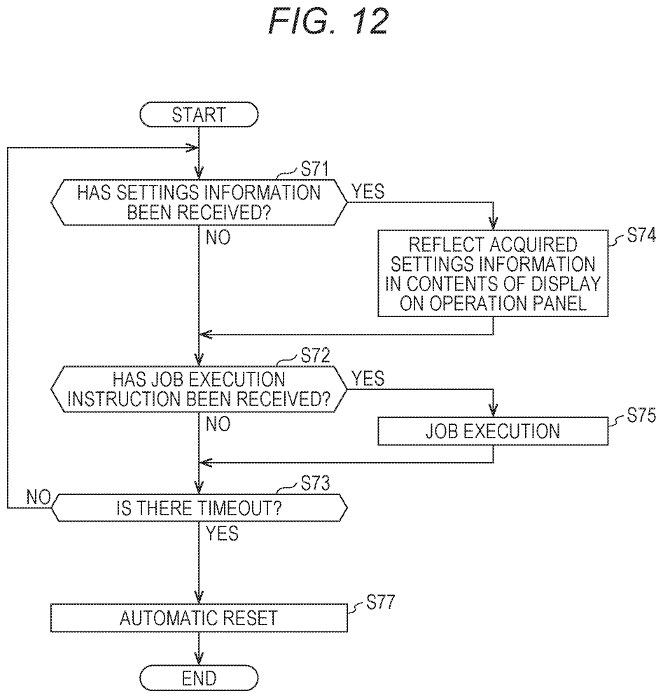

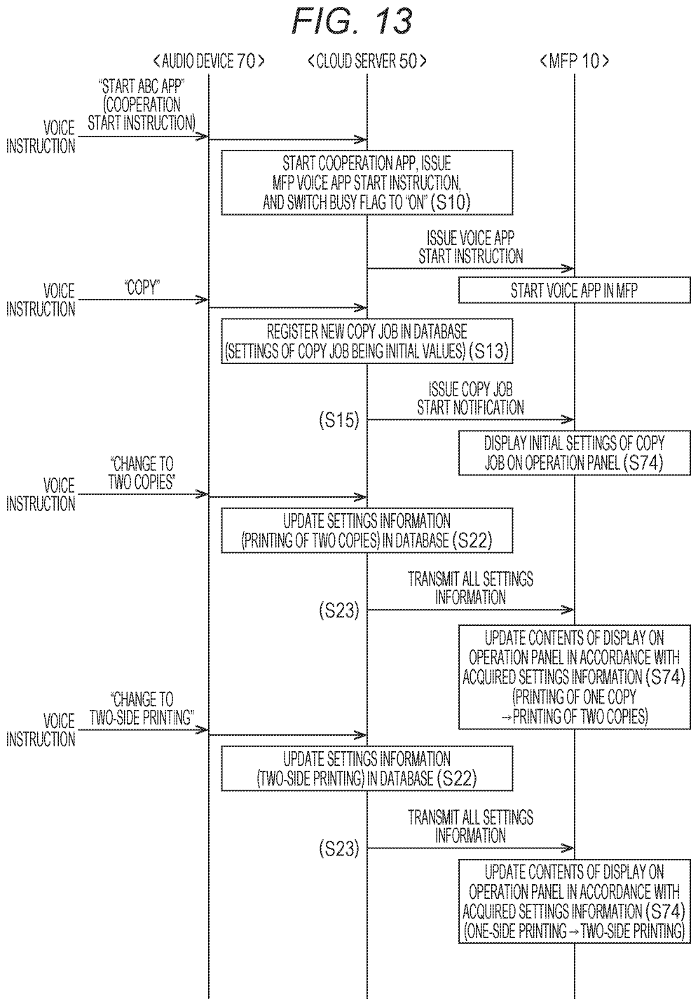

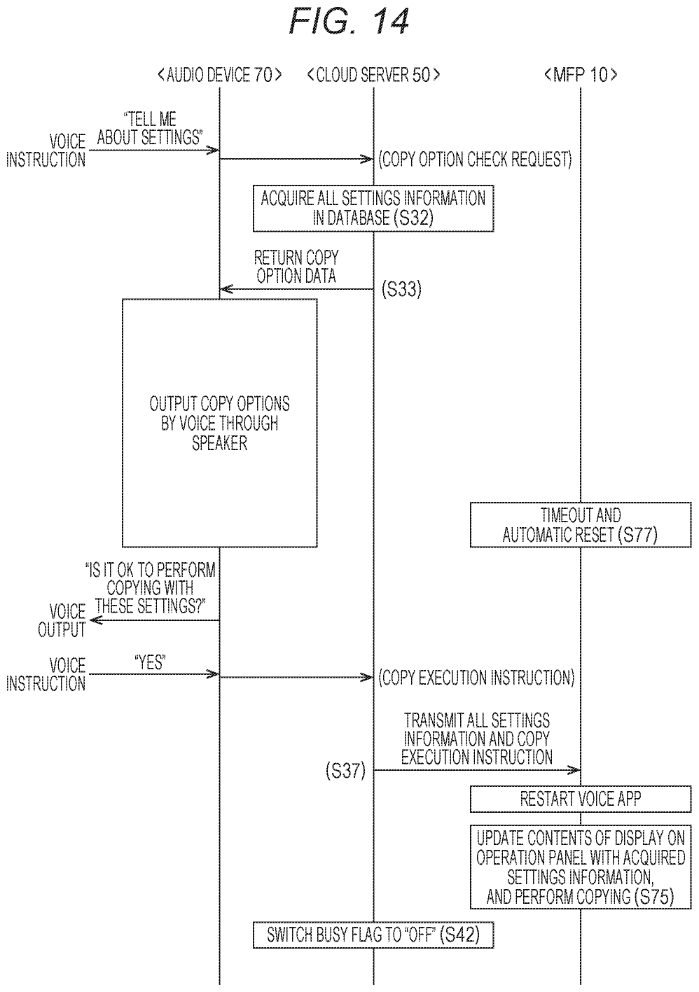

Next, specific operations in the image processing system 1 are described with reference to FIGS. 10 through 14. FIGS. 10 and 11 are flowcharts showing operation of the cloud server 50. FIG. 12 is a flowchart showing operation of the MFP 10. FIGS. 13 and 14 are timing charts showing an example of operations in the image processing system 1.

Here, the correspondence relationship (one-to-one correspondence relationship) between the plurality of MFPs 10 and the plurality of audio devices 70 is determined in advance. Specifically, an MFP 10A (ID=001 (see FIG. 5)) and an audio device 70A (ID=101) are associated with each other in advance, and an MFP 10B (ID=002) and an audio device 70B (ID=102) are associated with each other. For example, a user U1 can give voice instructions (including setting instructions) regarding various kinds of jobs to the MFP 10A, using the audio device 70A and the cloud server 50. Further, the user U1 (and another user U2) can give voice instructions (including setting instructions) regarding various kinds of jobs to the MFP 10B, using the audio device 70B and the cloud server 50.

In this embodiment, not only a voice instruction from an audio device 70 (an instruction via the cloud server 50) but also an instruction according to a direct user operation performed on the operation panel 18 of an MFP 10 (an instruction issued not via the cloud server 50) is accepted.

First, in step S10 (see FIGS. 10 and 13), a cooperation process among an audio device 70, the cloud server 50, and an MFP 10 is started.

Specifically, when a user utters a voice “Start ABC App” (a cooperative service start instruction), the audio device 70 (70A) accepts the input of the voice, and transmits the voice (voice data) to the cloud server 50. Note that “ABC App” is the specific name (unique name) of the MFP cooperating cloud application Q5 (application software cooperating with an MFP).

The cloud server 50 starts “ABC Application” (Q5) among a plurality of application software pieces (a “weather forecast application”, a “timetable application”, and “ABC Application (an application cooperating with an MFP)”, and the like) installed beforehand in the cloud server 50.

The cloud, server 50 (specifically, “ABC Application” (Q5)) then establishes a communication connection with the MFP 10 (10A) registered beforehand in association with the audio device 70 (70A). The cloud server 50 further gives an instruction to start the voice application Q1 to the MFP 10 (10A) (see also FIG. 13). The, voice application Q1 is application software (an application on the side of the MFP 10) for performing MFP operations (including a setting operation) by a user's voice. The voice application Q1 is an application of a plurality of applications installed beforehand in each MFP. In this manner, the cloud server 50 starts a cooperation process among the audio device 70 (70A), the cloud server 50, and the MFP 10 (10A).

In step S10, the cloud server 50 also switches the busy flag F1 to “ON”. The busy flag F1 is stored in the settings database 310 (FIG. 5). The busy flag F1 is a flag indicating whether the audio device 70 is being used for operating the MFP 10. The busy flag F1 can also be described as a flag indicating whether the cooperation process among the three sides 10, 50, and 70 is being performed. Here, the busy flag F1 is switched to “ON” in response to the start of the cooperation process (step S10), and is changed to “OFF” in response to the end of the cooperation process (step S42) (see FIGS. 11 and 14).

In step S11, not only a voice instruction from the audio device 70 (an instruction via the cloud server 50) but also an instruction according to a direct user operation performed on the operation panel 18 of the MFP 10 (an instruction issued not via the cloud server 50) is accepted.

In step S11, non-existence of any voice instruction for a predetermined period is also detected. If non-existence of any voice instruction for a predetermined period (120 seconds, for example) is detected in step S11, the cloud server 50 determines to cancel the connection with the audio device 70, and end the cooperation process. The operation then moves from step S41 (see FIG. 11) on to step S42. In step S42, the cloud server 50 switches the busy flag F1 to “OFF”, and ends the operation shown in FIGS. 10 and 11.

When a user instruction is accepted in step S11, a process corresponding to the contents thereof is performed. Specifically, the contents of the user instruction are determined in steps S12, S21, S27, S31, S34, and S43, and a process corresponding to the contents of the user instruction is performed. The operation then returns to step S11.

Specifically, if the user instruction is determined to be a new job generation instruction in step S12, the cloud server 50 generates (registers) a new job (step S13). For example, when the cloud server 50 receives a voice instruction “copy” via the audio device 70 (see also FIG. 13), the cloud server 50 determines that a new registration instruction for a copy job has been received, and newly registers a copy job. The copy job is associated with the MFP 10 (10A), and is registered in the cloud server 50. The cloud server 50 then transmits a copy job start instruction to the MFP 10 (step S15).

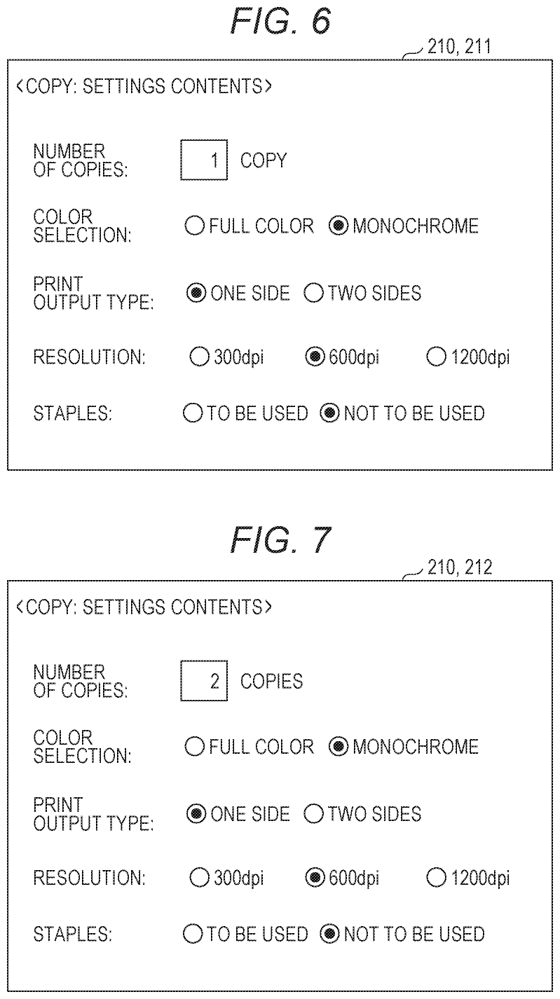

Upon receipt of the copy job generation instruction, the MFP 10 displays a setting screen 210 (an initial screen 211) (see FIG. 6) relating to the copy job, on the operation panel 18 of the MFP 10 (step S74 (FIG. 12)). In the initial screen (initial setting screen) 211, the set values relating to the respective setting items are set at the default values (initial values). Specifically, the set values of a plurality of (five) setting items (the number of copies, color selection, print output type, resolution, and staples) for the copy job are set at the default values (“1 copy”, “monochrome”, “one side”, “600 dpi”, and “not to be used”).

If the user instruction is determined to be a settings change instruction (an option change request) from the audio device 70 in step S21, the cloud server 50 updates the settings database 310 with the contents (settings contents) of the settings change instruction (step S22). In other words, the settings information based on the user instruction acquired from the audio device 70 is stored into the storage unit 55 of the cloud server 50 The cloud server 50 further transmits the settings information after the settings change (information about the set values relating to all the setting items among the five setting items in this case) to the MFP 10. Further, the MFP 10 updates the display contents of the setting screen 210 on the operation panel 18, on the basis of the received settings information.

For example, as shown in FIG. 13, when the cloud server 50 receives a voice instruction “Change to two copies” uttered by the user via the audio device 70, the cloud server 50 determines that a settings change instruction for changing the set value of the setting item “number of copies” to “two copies” has been issued. In accordance with the settings change instruction, the cloud server 50 changes the set value of the setting item “number of copies” in the settings database 310 to “two copies” (step S22). The cloud server 50 further transmits the settings information after the selling change (the latest settings information registered in the settings database 310) to the MFP 10 (step S23). Specifically, information about the set values (“two copies”, “monochrome”, “one side”, “600 dpi”, and “not to be used”) relating to all of the five setting items is transferred from the cloud server 50 to the MFP 10. Further, the MFP 10 updates the display contents of the setting screen 210 on the operation panel 18, on the basis of the received settings information (FIG. 7). In the updated setting screen 212 (FIG. 7), the set value of the setting item “number of copies” has been changed from “one copy” to “two copies”, as can be seen from a comparison with the initial screen 211 (FIG. 6).

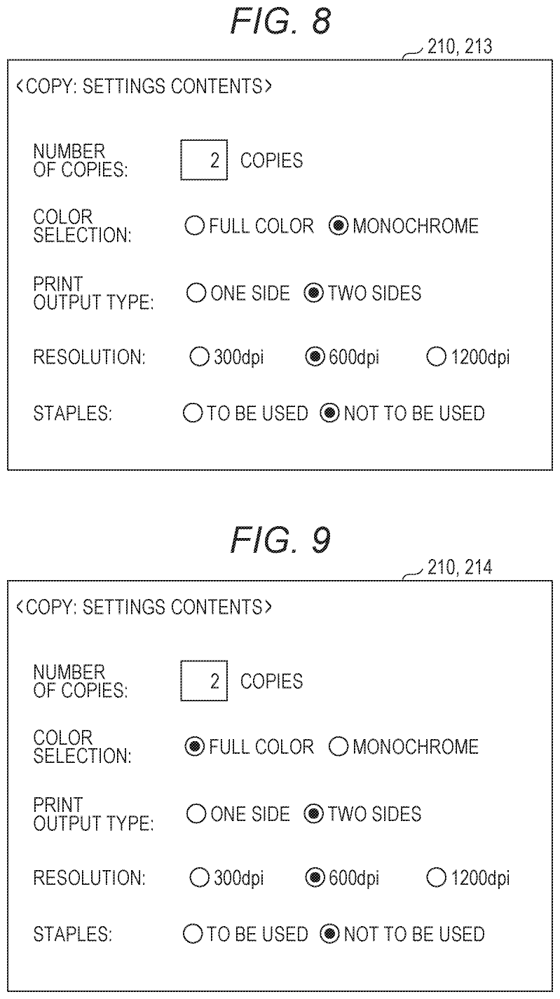

Likewise, as shown in FIG. 13, when the cloud server 50 receives a voice instruction “Change to two-side printing” uttered by the user via the audio device 70, the cloud server 50 determines that a settings change instruction for changing the set value of the setting item “print output type” to “two-side printing” has been issued. In accordance with the settings change instruction, the cloud server 50 changes the set value of the setting item “print output type” in the settings database 310 to “two-side printing” (step S22). The cloud server 50 further transmits the settings information after the setting change (the latest settings information registered in the settings database 310) to the MFP 10 (step S23). Specifically, information about the set values (“two copies”, “monochrome”, “two sides”, “600 dpi”, and “not to be used”) relating to all of the five setting items is transferred from the cloud server 50 to the MFP 10. Further, the MFP 10 updates the display contents of the setting screen 210 on the operation panel 18, on the basis of the received settings information (FIG. 8). In the updated setting screen 213 (FIG. 8), the set value of the setting item “print output type” has been changed from “one-side printing” to “two-side printing”, as can be seen from a comparison with the setting screen 212 (FIG. 7).

Further, during a setting process relating to a job, the settings contents can be changed through the operation panel 18 of the MFP 10. Although not shown in FIGS. 13 and 14, when the user directly operates the setting screen 210 displayed on the operation panel 18, for example, the MFP 10 can receive a setting operation directly from the user (not via the audio device 70).

Specifically, every time the settings are changed through the operation panel 18, the MFP 10 transmits an option change request (including information relating to the changed set value) to the cloud server 50. Upon receipt of the option change request or the like (step S27 (FIG. 10)), the cloud server 50 stores the information received from the MFP 10 (information including information relating to the set value changed through the operation panel 18) into the settings database 310. Through such a database update operation, not only the settings contents changed via the audio device 70 and the cloud server 50, but also the settings contents changed by the direct operation using the operation panel 18 are gathered in the settings database 310. Note that information about the set values relating to all the setting items gathered in the settings database 310 is transmitted from the cloud server 50 to the MFP 10 (or to the audio device 70) in steps S23 and S37 (and S33).

If the user instruction is determined to be a settings check instruction (an option check request) from the audio device 70 in step S31, the cloud server 50 acquires the settings information stored in the storage unit 55 (the settings database 310) (step S32). The cloud server 50 then transmits the acquired settings information to the audio device 70 (step S33). More specifically, the cloud server 50 transmits the latest settings information (the latest information about the set values relating to all the setting items among the five setting items in this case) to the audio device 70. The audio device 70 generates voice data based on the received settings information, and performs a voice output based on the voice data.

For example, as shown in FIG. 14, when the cloud server 50 receives a voice instruction “Tell me about settings” uttered by the user via the audio device 70, the cloud server 50 determines that a settings check instruction (an option check request) has been given by the user (step S31). The cloud server 50 acquires the latest settings information (the latest information about the set values relating to the five setting items (“two copies”, “monochrome”, “two sides”, “600 dpi”, and “not to be used”)) from the settings database 310, and transmits the acquired settings information to the audio device 70 (steps S32 and S33). The audio device 70 generates voice data based on the received settings information, and performs a voice output based on the voice data. Specifically, “The set value of the number of copies is two, the set value of color selection is monochrome, the set value of print output type is two-side printing, the set value of resolution is 600 dpi, and the set value of stables is “not to be used”.” is output by voice from the audio device 70.

Further, the audio device 70 outputs “Is it OK to perform copying with these settings?” by voice. When the user determines (confirms) that the settings contents output by voice are the desired settings contents, the user utters and. inputs “Yes” to the audio device 70. The utterance of “Yes” is input to the cloud server 50 via the audio device 70, and is interpreted as a job execution instruction (a copy output instruction or the like) by the cloud server 50. If the settings contents output by voice are not the desired settings contents, the user continues the settings change operation by voice or the like.

If the user instruction is determined to be a job execution instruction (a copy output instruction or the like) from the audio device 70 in step S34, the cloud server 50 acquires the settings information stored in the storage unit 55 (the settings database 310). The cloud server 50 then transmits the acquired latest settings information (the latest information about the set values relating to the five setting items (“two copies”, “monochrome”, “two sides”, “600 dpi”, and “not to be used”), for example), and a job execution instruction (a print execution instruction) to the MFP 10 (step S37).

Upon receipt of the job execution instruction and the latest settings information (step S72 (FIG. 10)), the MFP 10 performs a copy output process based on the settings information (step S75). At this stage, the MFP 10 may update and display the setting screen 210 in the operation panel 18, on the basis of the received settings information. Note that the cloud server 50 discards the job data after the job is completed (step S38).

As shown in FIG. 14, for example, during the readout of the settings information by the audio device 70 in accordance with a settings check instruction (an option check request), the elapse of the predetermined non-instruction period (a timeout) might be detected (step S73 (FIG. 12)), and an automatic reset (step S77) might occur in the MFP 10. In this example, when an automatic reset occurs, the voice application Q1 is temporarily terminated, and the backlight of the touch panel 19 of the operation panel 18 is turned off so that the screen becomes black (blacks out).

Even when an automatic reset occurs, the processing in step S37 described above or the like is performed. Upon receipt of information from the cloud server 50, the MFP 10 (automatically) restarts the voice application Q1, and bands over the information (settings information and a print execution instruction) to the voice application Q1. In response to this, the voice application Q1 performs the processing in step S75 described above. Specifically, the voice application Q1 (the MFP 10) performs a copy output process based on the received settings information (and a process of updating and displaying the setting screen 210 of the operation panel 18 on the basis of the settings information, or the like).

After that, if it is determined in step S11 that no voice has been emitted for a predetermined period, the operation moves from step S41 on to step S42 as described above. Alternatively, when an explicit end instruction (a voice instruction) is given by the user (see step S43), the operation moves on to step S42. In step S42, the cloud server 50 switches the busy flag F1 to “OFF”, and ends the operation shown in FIGS. 10 and 11, as described above.

In the operation described above, when a cooperation process among the three sides 10, 50, and 70 is being continued, the cloud server 50 transmits settings information about all the setting items in a plurality of predetermined setting items to the MFP 10, every time a settings change (in accordance with a voice instruction) is made via the audio device 70 and the cloud server 50. Such a transmission operation is performed both before the occurrence of an automatic reset in the MFP 10 (before the elapse of the predetermined non-instruction period) and after the occurrence of the automatic reset (after the elapse of the predetermined non-instruction period). Particularly, as the transmission operation is performed after the automatic reset, the MFP 10 can reproduce the settings contents that were set until immediately before the automatic reset, on the basis of the settings information received from the cloud server 50. Thus, even in a case where the settings contents are reset in response to the elapse of the non-instruction period during which no instructions were issued from the cloud server 50, the user does not need to perform the setting again from the beginning.

In the embodiment described above, the settings information in the settings database 310 is transmitted from the cloud server 50 to the MFP 10, every time a voice instruction from the user is generated. In other words, in a case where a plurality of unit instructions (a plurality of unit voice instructions) is given as a user instruction to the audio device 70, the settings information in the settings database 310 is updated for each unit instruction (or every time a unit instruction is given), and the latest settings information updated for each unit instruction is sequentially transmitted from the cloud server 50 to the MFP 10 for each unit instruction. In such a mode, the settings information in the settings database 310 is updated for each unit instruction. Accordingly, even if an automatic reset occurs in the MFP 10 at some point in time, the latest settings information (the latest settings contents) is always stored in the settings database 310. Because of this, the latest settings contents can be reproduced in the MFP 10, and thus, there is no need for the user to perform the setting again from the beginning.

Further, regardless of whether it is before or after the occurrence of an automatic reset, settings contents (the latest settings contents) based on settings information that has been updated for each unit instruction and been transmitted from the cloud server 50 for each unit instruction are displayed on the operation panel 18 of the MFP 10. Thus, the latest settings information (settings information reflecting the contents of the latest instruction issued by the user) is constantly displayed on the setting screen 210 of the operation panel 18, regardless of whether it is before or after the occurrence of an automatic reset.

Further, in the above embodiment, not only the settings change contents based on voice instructions issued via the audio device 70 but also the settings change contents based on operation instructions (settings change operations) issued via the operation panel 18 are gathered in the settings database 310. Every time a settings change (in accordance with a voice instruction) is made via the audio device 70 and the cloud server 50. all the settings information (the settings information gathered in the settings database 310) is transmitted from the cloud server 50 to the MFP 10. Thus, the contents set by the two kinds of setting techniques (both the setting technique using the audio device 70 and the setting technique not using the audio device 70) can be appropriately reproduced even after an automatic reset.

### 2. Second Embodiment

A second embodiment is a modification of the first embodiment. The description below will focus on the differences from the first embodiment.

In the first embodiment described above, after an automatic reset in an MFP 10, the cloud server 50 automatically (spontaneously) transmits the settings information in the storage unit 55 of the cloud server 50 to the MFP 10. In short, a “push” transmission process from the cloud server 50 to the MFP 10 is performed. Specifically, depending on a result of a determination operation performed by the cloud server 50 (whether a cooperation process by the three sides 10, 50, and 70 is being continued), the cloud server 50 automatically (spontaneously) transfers the settings information in the storage unit 55 of the cloud server 50 to the MFP 10. The MFP 10 reproduces the contents of a user instruction in the storage unit 5 of the MFP 10, on the basis of the settings information transmitted from the cloud server 50.

However, the present invention is not limited to this, and, in addition to (or instead of) such a “push” transmission process, a “pull” transmission process or the like may be performed.

For example, in response to a user operation (such as a touch operation on the touch panel 19) performed on the operation panel 18 after an automatic reset of the MFP 10, the MFP 10 may inquire of the cloud server 50 whether a cooperation process by the three sides 10, 50, and 70 is being continued. In a case where response contents to the effect that the cooperation process is being continued are received from the cloud server 50, the MFP 10 transmits a settings information transmission request to the cloud server 50, and, in response to the transmission request, the cloud server 50 transmits the settings information in the storage unit 55 of the cloud server 50 to the MFP 10. The MFP 10 then reproduces the contents of the user instruction in the storage unit 5 of the MFP 10, on the basis of the settings information transmitted from the cloud server 50. In this manner, an information acquisition process (a “pull” information acquisition process) or the like in which the MFP 10 actively draws information from the cloud server 50 may be performed.

In the second embodiment, such a mode will be described.

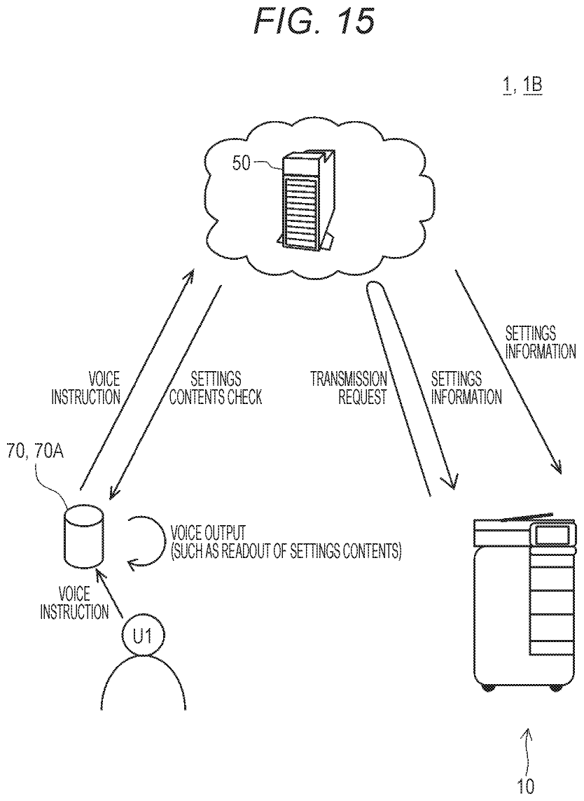

FIG. 15 is a conceptual diagram showing an outline of operation of an image processing system 1 (1B) according to the second embodiment. As can be seen from a comparison between FIG. 15 and FIG. 4, the second embodiment differs from the first embodiment in that settings information can also be transmitted from the cloud server 50 to the MFP 10 in response to a transmission request from the MFP 10 to the cloud server 50.

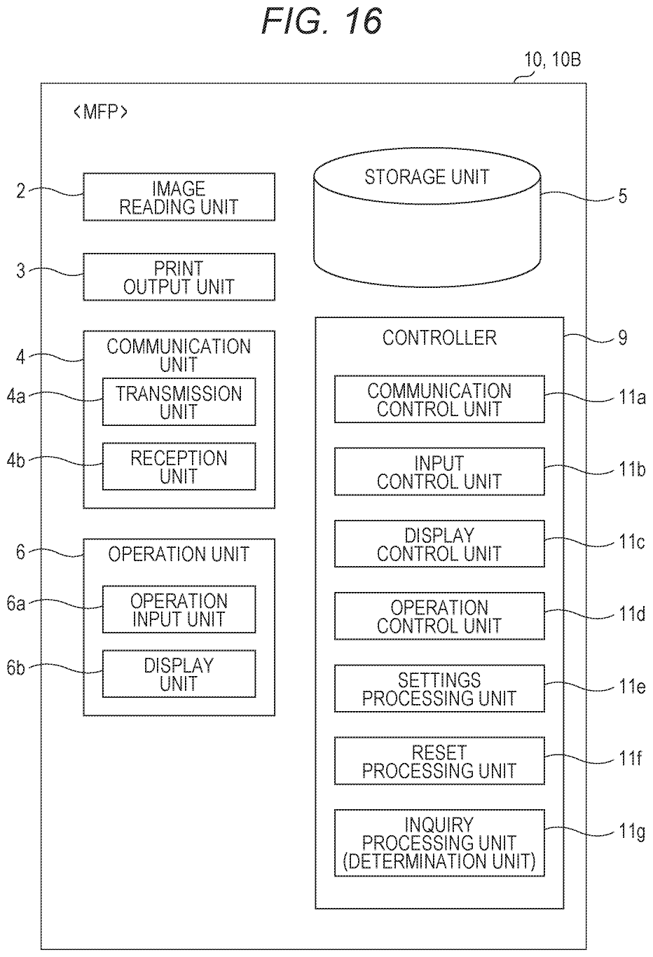

FIG. 16 is a diagram showing the functional blocks of the MFP 10 according to the second embodiment. As shown in FIG. 16, the MFP 10 according to the second embodiment further includes an inquiry processing unit 11g. The inquiry processing unit 11g is a processing unit that inquires of the cloud server 50 whether a cooperation process by the three sides 10, 50, and 70 is being continued. The inquiry processing unit 11g is formed by execution of a voice application Q1 or the like.

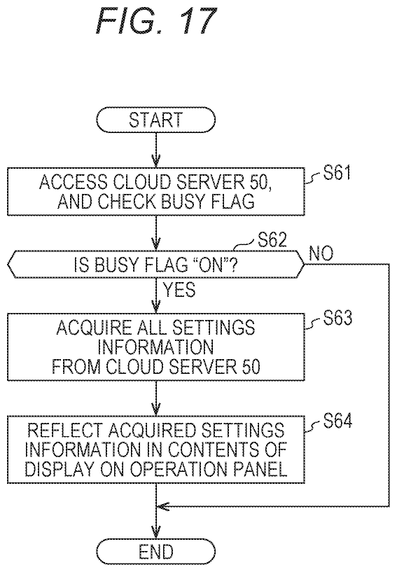

FIG. 17 is a flowchart showing the operation of the MFP 10 immediately after the voice application Q1 that has once been ended due to an automatic reset is restarted (in response to a user operation). In the MFP 10 of the second embodiment, the operation shown in FIG. 17 is performed in addition to the operation shown in FIG. 12.

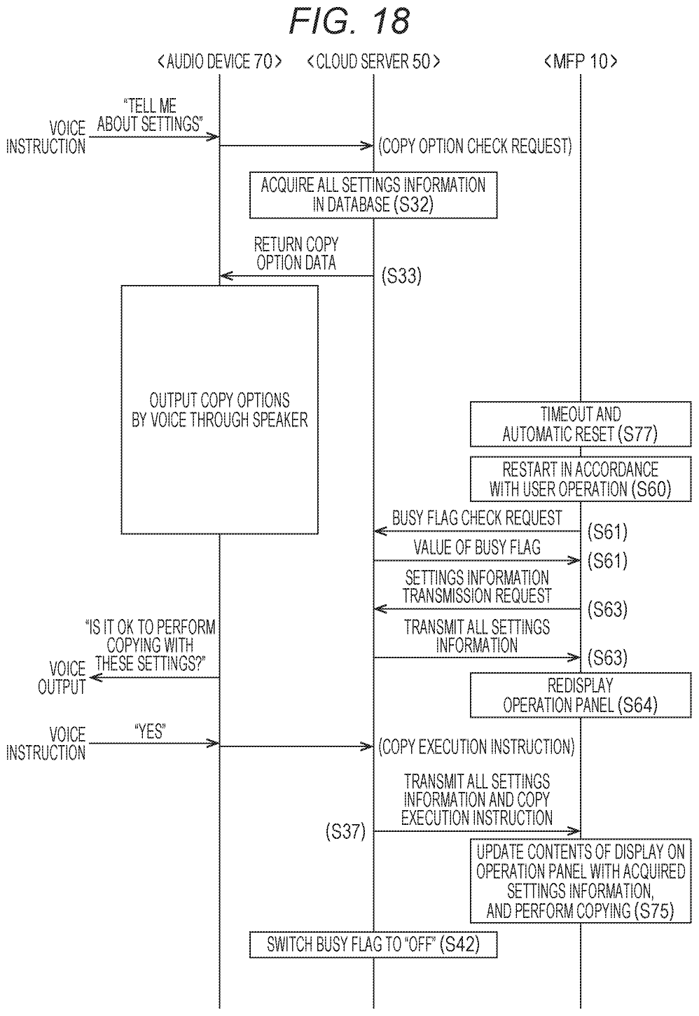

FIG. 18 is a timing chart showing part of an example operation of the image processing system 1 (1B) according to the second embodiment. In the second embodiment, the operation shown in FIG. 13 and the operation shown in FIG. 18 are performed in this order. In other words, the operation shown in FIG. 18 is performed, instead of the operation shown in FIG. 14.

As shown in FIG. 17, FIG. 18, and others, in the second embodiment, after a predetermined, non-instruction period has elapsed in the MFP 10, and an automatic reset has occurred (step S77 (FIG. 12)), the voice application Q1 is restarted in the MFP 10 in response to a user operation (step S60). The user operation may be a touch operation (a touch operation on the touch panel 19 of the operation panel 18) performed by a user who intends to restore a screen that has blacked out due to an automatic reset. More specifically, when an automatic reset occurs in the MFP 10, the voice application Q1 ends, and the operation panel 18 enters a blackout state. When a user in the vicinity of the MFP 10 visually recognizes the operation panel 18 in the blackout state, the user performs a touch operation on the operation panel 18 (the touch panel 19) with the intention of returning the blackout state to the original state. Note that the operation panel 18 can accept a touch operation (a restart operation for the voice application Q1) or the like performed by a user even in the blackout state. In response to the touch operation, the voice application Q1 restarts.

The voice application Q1 (the MFP 10) that has restarted inquires of the cloud server 50 whether the cooperation process among the three sides 10, 50, and 70 is still being continued (step S61 (see FIGS. 17 and 18)).

Specifically, the MFP 10 transmits a request to check the value of a busy flag F1 to the cloud server 50, and, in response to the check request, the cloud server 50 returns the value of the busy flag F1 to the MFP 10. In this manner, the information about the busy flag F1 is shared by both the cloud server 50 and the MFP 10. As the cloud server 50 and the MFP 10 share the information about the busy flag F1, both the cloud server 50 and the MFP 10 can determine whether the cooperation process is being continued.

If the returned value of the busy flag F1 is “OFF” (FALSE) (NO in step S62), the MFP 10 determines that response contents to the effect that “the cooperation process is not being continued” have been received (in other words, “the cooperation process is not being continued”), and ends the process shown in FIG. 17, without carrying out steps S63 and S64.

If the returned value of the busy flag F1 is “ON” (TRUE) (YES in step S62), on the other hand, the MFP 10 determines that response contents to the effect that “the cooperation process is (still) being continued” have been received (in other words, “the cooperation process is being continued”), and acquires the settings information stored in the storage unit 55 (the settings database 310) (step S63). Specifically, the MFP 10 transmits, to the cloud server 50, a request to transmit the settings information stored in the storage unit 55 (the settings database 310), and receives the settings information (specifically, information about the respective set values relating to all the setting items in a plurality of setting items) returned from the cloud server 50 in response to the transmission request. The MFP 10 then stores the received (acquired) settings information into the storage unit 5, and performs a setting process again. At the same time, the MFP 10 redisplays the setting screen 210 based on the settings information on the operation panel 18 (step S64).

After that, in FIG. 18, a print output process is performed (step S75) while the redisplay state of the operation panel 18 after the automatic reset is maintained (without the occurrence of another automatic reset).

As described above, settings information may be transmitted from the cloud server 50 to the MFP 10, in accordance with a transmission request from the MFP 10.

### Modifications of the Second Embodiment

In the second embodiment described above, an automatic reset of the operation panel 18 occurs during a copy option readout process, and, after the automatic reset, the redisplay of the operation panel 18 is performed on the basis of the information in the settings database 310 of the cloud server 50, in response to a user operation. However, the present invention is not limited to that.

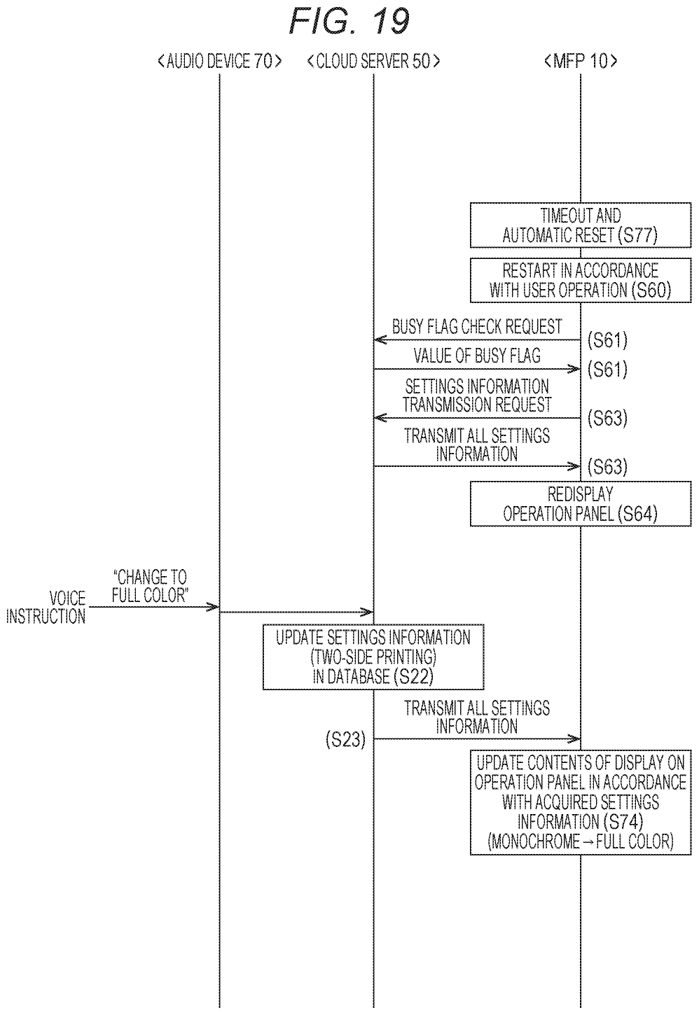

For example, as shown in FIG. 19, even in a case where an automatic reset occurs at another timing (a timing between the time of a certain setting instruction by voice and the time of another setting instruction by voice), the redisplay or the operation panel 18 or the like may be performed on the basis of the information in the settings database 310 of the cloud server 50, in response to a user operation. The operation shown in FIG. 19 is performed between the operation shown in FIG. 13 and the operation shown in FIG. 14. FIG. 19 shows a situation in which an automatic reset has occurred between a voice instruction to make a settings change to “two-side printing” (see FIG. 13) and a voice instruction to make a settings change to “full color” (see FIG. 19). In other words, FIG. 19 shows a situation in which, after a voice instruction regarding two-side printing was issued, a predetermined non-instruction period has elapsed, and an automatic reset has occurred.

Further, in the second embodiment (FIG. 18), a print output process is performed (step S75) while the redisplay state of the operation panel 18 after an automatic reset is maintained (FIG. 18). However, the present invention is not limited to that. For example, after the operation shown in FIG. 19 is performed, the same operation as that shown in FIG. 14 may be performed, such as an automatic reset occurring (again) immediately before the print output process, as in the first embodiment. That is, the operation shown in FIG. 13, the operation shown in FIG. 19, and the operation shown in FIG. 14 may be performed in this order.

Further, in the second embodiment, after an automatic reset, a settings information transmission request is sent from the MFP 10 to the cloud server 50, and settings information is transmitted from the cloud server 50 to the MFP 10. However, the present invention is not limited to that. For example, the MFP 10 may transmit a request to check the busy flag F1 to the cloud server 50 at predetermined time intervals (every 5 seconds, for example), regardless of whether it is before or after an automatic reset. In a case where it is observed that the busy flag F1 is ON, the MFP 10 may send a settings information transmission request to the cloud server 50, and perform a setting process or the like in the MFP 10 on the basis of the settings information (the information in the settings database 310) returned from the cloud server 50 in response to the transmission request.

### 3. Third Embodiment

A third embodiment is a modification of the first embodiment and the like. The description below will focus on the differences from the first embodiment and the like.

In the first embodiment and the like described above, in a case where a plurality of unit instructions (such as a settings change instruction relating to the number of copies, and a settings change instruction relating to the print output type) is issued as a user instruction to an audio device 70, every time one of the unit instructions is issued, information about the set values of all the setting items in a plurality of (five, for example) setting items is collectively transmitted as the settings information.

However, the present invention is not limited to that. For example, the information (the transmission target information) to be transmitted from the cloud server 50 to an MFP 10 may be changed, depending on whether an automatic reset has occurred.

In the third embodiment, such a mode will be described.

The cloud server 50 according to the third embodiment further includes a situation determination unit 59f (not shown). The situation determination unit 59f is a processing unit that determines whether an automatic reset of an MFP 110 has occurred (whether the settings information stored in the storage unit 5 has been reset in response to the elapse of a predetermined non-instruction period), through communication with the MFP 10. The situation determination unit 59f is formed by execution of a cooperation app or the like in the cloud server 50.

In the third embodiment, when the predetermined non-instruction period relating to the MFP 10 has not elapsed yet (in a situation where an automatic reset has occurred), only the difference information between information about the set value of at least one setting item changed in accordance with a plurality of unit instructions in a plurality of setting items, and information already transmitted to the MFP 10 is transmitted. In other words, of the information about the set value of at least one setting item changed as needed in accordance with a plurality of unit instructions, only the information that has not been transmitted to the MFP 10 is transmitted. In short, only the difference information between the information about the set value changed in accordance with a user instruction or the like and the information already transmitted to the MFP 10 is transmitted.

More specifically, in the (N+1)th (third, for example; N being a natural number) transmission process relating to settings information, the information that has already been transmitted before and in the Nth (second, for example) transmission process relating to settings information is not transmitted. Only the information that has not been transmitted before and in the Nth (second) transmission process (the information about the newly changed set value (the set value of a certain setting item)) is transmitted in the (N+1)th (third) transmission process.

On the other hand, when the predetermined non-instruction period relating to the MFP 10 has elapsed (in a situation where an automatic reset has occurred), the information about the set values of all the setting items in a plurality of setting items is collectively transmitted.

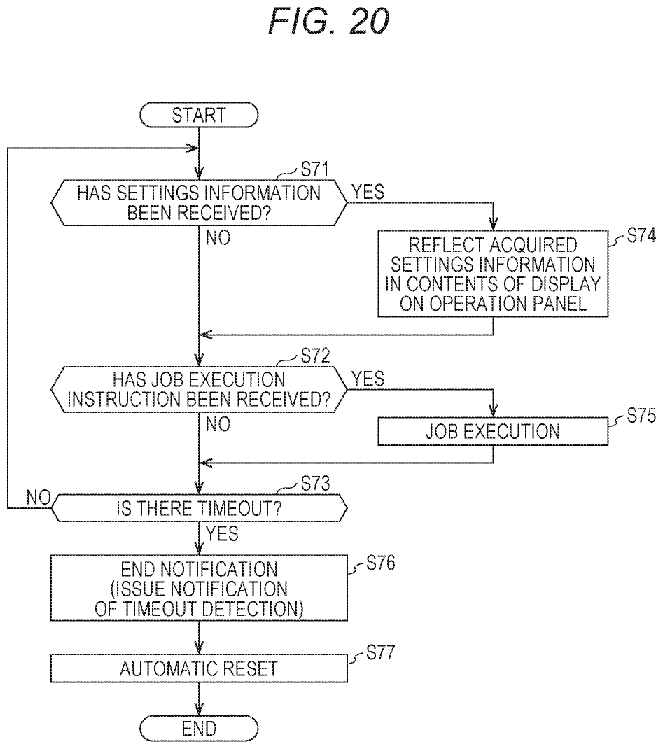

FIG. 20 is a flowchart showing operation of an MFP 10 according to the third embodiment. In the MFP 10 of the third embodiment, the operation shown in FIG. 20 is performed, instead of the operation shown in FIG. 12. As can be seen from a comparison between FIG. 12 and FIG. 20, the process in step S76 is added in FIG. 20. If a timeout occurs in step S73, the MFP 10 in step S76 transmits a notification of the occurrence of a timeout and a notification of the occurrence of an automatic reset accompanying the timeout, to the MFP 10. Note that the automatic reset occurrence notification may be transmitted after the actual occurrence of an automatic reset, or may be transmitted immediately before the occurrence of an automatic reset as shown in FIG. 20.

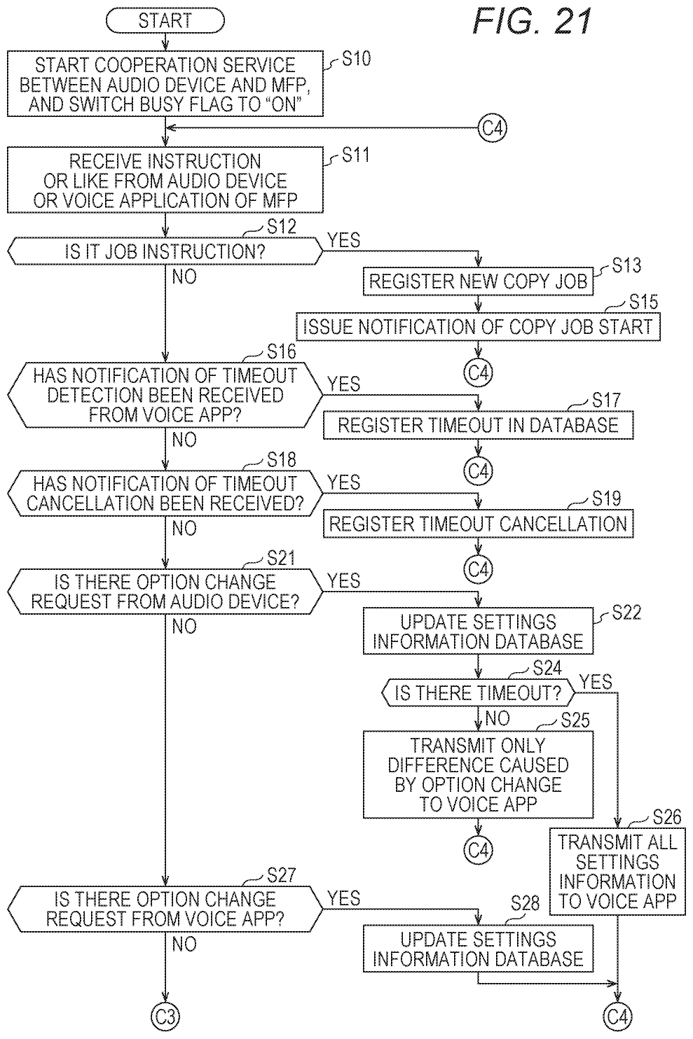

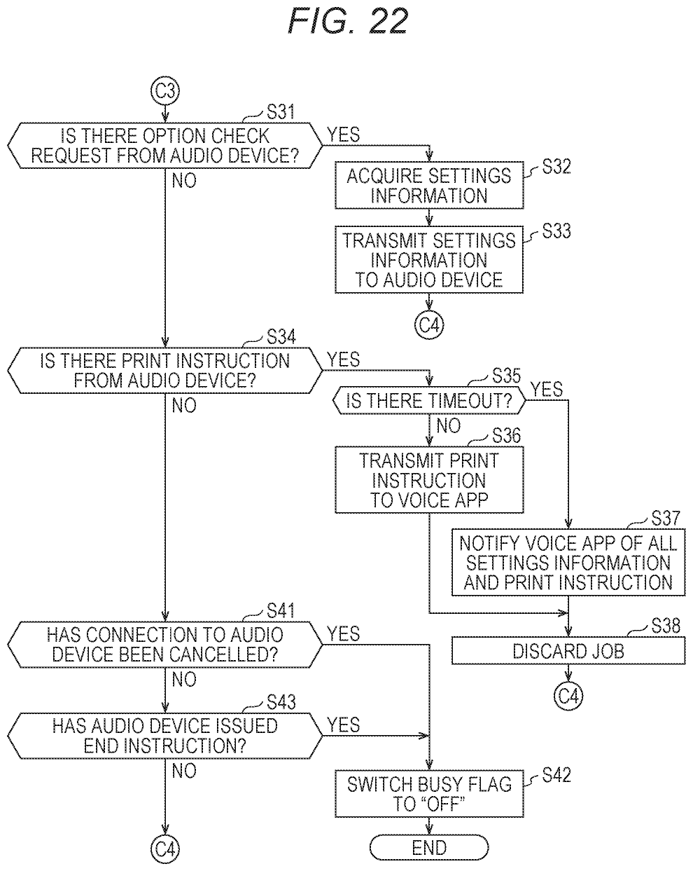

FIGS. 21 and 22 are flowcharts showing operation of the cloud server 50 according to the third embodiment. In the cloud server 50 of the third embodiment, the operation shown in FIGS. 21 and 22 is performed, instead of the operation shown in FIGS. 10 and 11 (an operation according to the first embodiment). As can be seen from a comparison between these flowcharts according to the two embodiments, the processes in steps S16 through S19, S24 through S26, S35, and S36 are added in FIGS. 21 and 22.

As shown in FIG. 21, when the cloud server 50 receives a timeout notification from the MFP 10 (voice application Q1) (step S16), the cloud server 50 registers “a timeout occurrence state (in the MFP 10)” in the settings database 310 (step S17).

On the other hand, when the cloud server 50 receives a timeout cancellation notification from the MFP 10 (voice application Q1) (step S18), the cloud server 50 registers cancellation of a “timeout occurrence state” in the settings database 310 (step S19). Note that the timeout cancellation notification is transmitted from the MFP 10 to the cloud server 50 immediately after the voice application Q1 is restarted in the MFP 10.

Further, if the user instruction is determined to be a settings change instruction (an option change request) from the audio device 70 (step S21), the settings database 310 is updated with the contents (settings contents) of the settings change instruction (step S22), and the operation then moves on to step S24. In step S24, a check is made to determine whether a timeout has occurred, on the basis of the settings database 310. If a timeout has not occurred, only the difference information between the information about the set value changed in accordance with the user instruction or the like and the information already transmitted to the MFP 10 is transmitted to the MFP 10 (step S25). If a timeout has occurred, on the other hand, the information about the set values of all the setting items in a plurality of predetermined setting items is collectively transmitted to the MFP 10 (step S26).

If the user instruction is determined to be a print instruction (a copy job execution instruction) from the audio device 70 (step S34), the operation moves on to step S35. In step S35, a check is made to determine whether a timeout has occurred, on the basis of the settings database 310. If a timeout has not occurred, only the print instruction is transmitted to the MFP 10 (step S36). If a timeout has occurred, on the other hand, the print instruction and information about the set values of all the setting items in the plurality of setting items are transmitted (step S37).

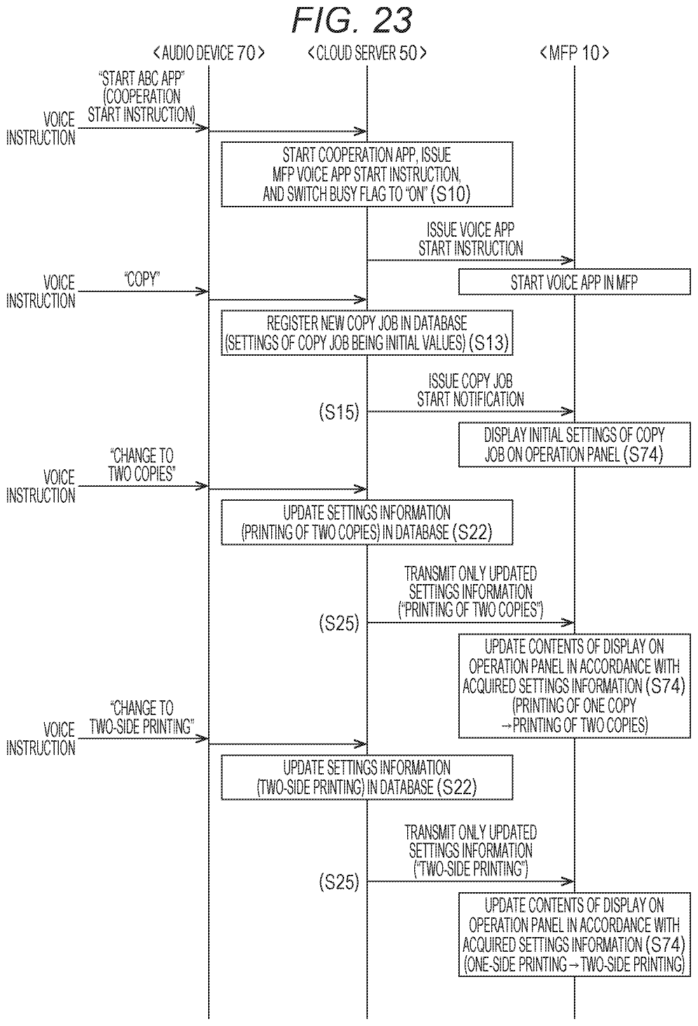

FIGS. 23 through 25 are timing charts showing an example operation in the image processing system 1 according to the third embodiment. The operation according to the third embodiment will be further described with reference to these drawings.

The operations in accordance with the first two voice instructions (“Start ABC App (an MFP cooperation application)” and “Copy”) are the same as those in the first embodiment.

After that, when a voice instruction relating to the number of copies (“Change to two copies”) is issued by the audio device 70 (see the middle portion of FIG. 23), the cloud server 50 updates the settings database 310, and then transmits only the updated settings information (“printing of two copies”) to the MFP 10 (step S25). On the basis of the acquired information, the MFP 10 updates the setting screen 210. Note that the same screen 212 (FIG. 7) as that of the first embodiment is displayed as the setting screen 210.

When a voice instruction relating to a print output type change (“Change to two-side printing”) is issued by the audio device 70, the cloud server 50 updates the settings database 310, and then transmits only the updated settings information (“two-side printing”) (the information other than the already transmitted updated information) to the MFP 10. On the basis of the acquired information, the MFP 10 updates the setting screen 210. Note that the same screen 213 (FIG. 8) as that of the first embodiment is displayed as the setting screen 210.

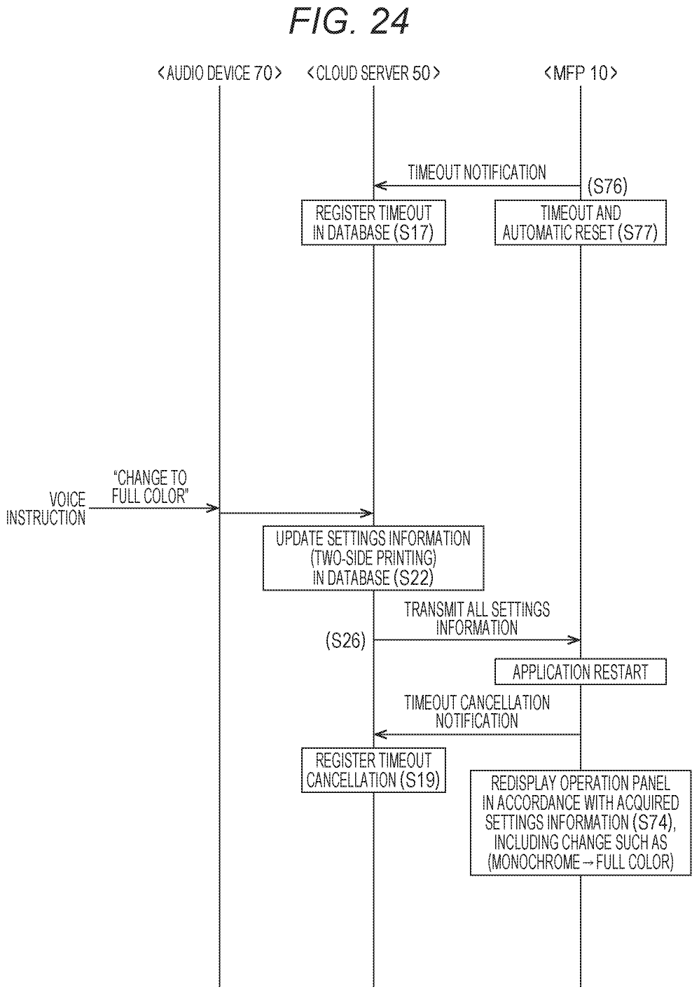

After that, when the predetermined non-instruction period has elapsed (a timeout occurs) in the MFP 10, a timeout notification is transmitted from the MFP 10 to the cloud server 50 (step S76), and an automatic reset occurs in the MFP 10 (step S77), as shown in FIG. 24. On the basis of the timeout notification from the MFP 10, the cloud server 50 registers a “timeout occurrence state” in the settings database 310 (step S17).

Further, when a voice instruction relating to color selection (“Change to full color”) is issued by the audio device 70 (see FIG. 24), the cloud server 50 updates the settings database 310, and then detects a timeout occurrence state in the MFP 10, on the basis of the settings database 310. In accordance with the result of this detection, the cloud server 50 transmits not only the updated information (“full-color printing”) but also the information about the respective set values of (or the values set for) all the setting items as the settings information to the MFP 10 (step S26). That is, the information about the set values of all the setting items in a plurality of (five in this example) setting items is collectively transmitted as the settings information. The MFP 10 automatically restarts the voice application Q1 in response to the reception of the information, and, after the restart, transmits a timeout cancellation notification to the cloud server 50. On the basis of the received timeout cancellation notification the cloud server 50 registers cancellation of the “timeout occurrence state” in the settings database 310 (step S19). Further, the MFP 10 updates the setting screen 210, on the basis of the settings information acquired from the cloud server 50. Note that a screen 214 (see FIG. 9) is displayed as the setting screen 210.

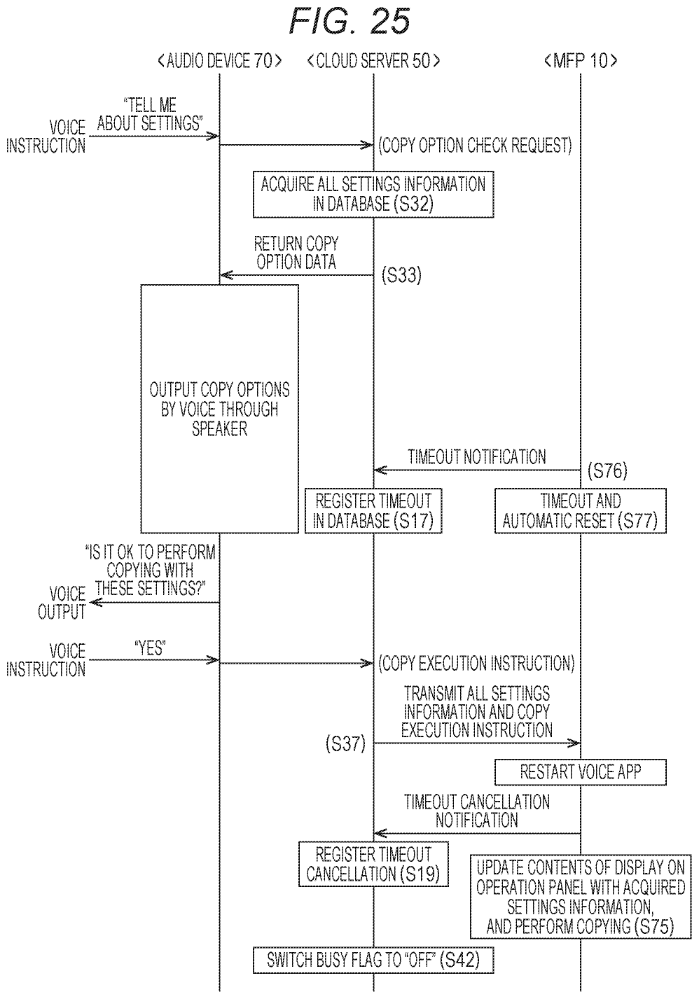

The operation in response to the next voice instruction (the operation in response to “Tell me about settings” (operations of the audio device 70 and the cloud server 50)) is almost the same as that of the first embodiment (see FIG. 25). Further, a timeout occurs in the MFP 10 while the audio device 70 reads out the settings information, as in the first embodiment. In the third embodiment, however, a timeout notification process (step S76), a timeout occurrence state registration process (step S17), and the like are further performed, as shown in FIG. 25.

After that, when a copy execution instruction (“Yes”) is issued, the cloud server 50 detects the timeout occurrence state in the MFP 10, on the basis of the settings database 310. In response to this, the cloud server 50 transmits not only the copy execution instruction (a print instruction) but also the information about the respective set values of (or the values set for) all the setting items, to the MFP 10 (step S37). The MFP 10 restarts the voice application Q1 in response to the reception of the copy execution instruction and the reception of the settings information, and, after the restart, transmits a timeout cancellation notification to the cloud server 50. On the basis of the received timeout cancellation notification, the cloud server 50 registers cancellation of the “timeout occurrence state” in the settings database 310 (step S19). The MFP 10 also updates and displays the setting screen 210 on the basis of the settings information acquired from the cloud server 50, and performs a print output (a copy output) on the basis of the copy execution instruction and the settings information acquired from the cloud server 50.

As described above, the information (the transmission target information) to be transmitted from the cloud server 50 to an MFP 10 may be changed, depending on whether an automatic reset has occurred.

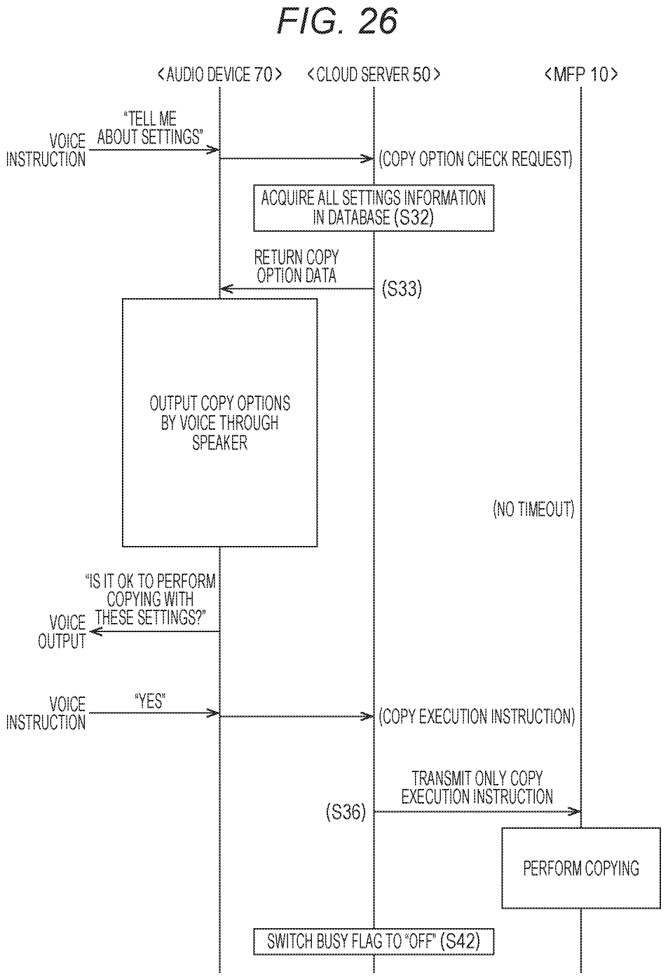

FIG. 26 is a timing chart showing another example operation according to the third embodiment. In this other example operation, the operation shown in FIG. 26 is performed, instead of the operation shown in FIG. 25. In FIG. 26, a timeout does not occur in the MFP 10 while the audio device 70 reads out the settings information. When a copy execution instruction (“Yes”) is issued, the cloud server 50 that has received the copy execution instruction detects a timeout non-occurrence state in the MFP 10, on the basis of the settings database 310. In response to this, the cloud server 50 transmits only the copy execution instruction (a print instruction) to the MFP 10 (step S36), but does not transmit the settings information in the settings database 310 to the MFP 10. The MFP 10 then performs a print output (a copy output), in accordance with the copy execution instruction acquired from the cloud server 50.

As described above, the process in step S36 may be performed, on the basis of a result of the branching process in step S35.

With the third embodiment described above, it is also possible to achieve the same effects as those of the first embodiment. Particularly in the third embodiment, depending on the situation, only the difference information (information yet to be transmitted) among the pieces of the settings information relating to all the setting items is transmitted from the cloud server 50 to the MFP 10 (step S25), and thus, the communication traffic can be reduced. Further, between a copy execution instruction (a print instruction) and settings information, only the copy execution instruction is transmitted depending on the situation (step S36) (the settings information is not transmitted). Thus, an increase in communication traffic can be prevented.

### Another Modifications of the Third Embodiment

In the third embodiment, in a case where the settings information has been reset in response to the elapse of a predetermined non-instruction period (or in a situation where an automatic reset has occurred), information about the set values of all the setting items in a plurality of setting items is collectively transmitted as the settings information. However, the present invention is not limited to that. For example, in a case where the settings information has been reset in response to the elapse of a predetermined non-instruction period, information about the set value of at least one setting item (for example, only the three items: the number of copies, color selection, and print output type) changed in accordance with a plurality of unit instructions may be collectively transmitted as the settings information.

### 4. Modifications and Others

Although embodiments of the present invention have been described so far, the present invention is not limited to the above described embodiments.

For example, in each of the above embodiments, the latest settings information updated for each unit instruction is sequentially transmitted from the cloud server 50 to an MFP 10 for each unit instruction. However, the present invention is not limited to that. For example, after a plurality of unit instructions issued as a user instruction to an audio device 70 is executed, settings information (the settings information stored in the storage unit 55) reflecting all of the plurality of unit instructions may be collectively transmitted from the cloud server 50 to an MFP 10. Particularly, in a case where various kinds of settings contents are not displayed on the operation panel 18 of the MFP 10 (or in a case where a voice operation using the audio device 70 is performed exclusively, and the operation panel 18 is not used), it is preferable to perform such collective transmission.

Further, in each of the above embodiments, the contents of settings changes using the operation panel 18 are sequentially transmitted from an MET 10 to the cloud server 50. However, the present invention is not limited to that. For example, in a case where the operation panel 18 accepts a plurality of settings change operations from the user, the MFP 10 may collectively transmit information updated for the respective set values in accordance with the plurality of settings change operations to the cloud server 50. More specifically, every time a settings change operation is accepted by the operation panel 18, the MFP 10 may store information about the respective set values changed by the settings change operation into the storage unit 5, and collectively transmit the information stored in the storage unit 5 of the MFP 10 to the cloud server 50 immediately before resetting in response to the elapse of a predetermined non-instruction period. The cloud server 50 then stores information including the received information as the settings information into the settings database 310.

In each of the above embodiments, a check is made to determine whether a cooperation process among the three sides of an audio device 70 (an external device), the cloud server 50, and an MFP 10 (an image processing apparatus) is being performed, on the basis of the value (ON/OFF) of the busy flag F1 (stored in the cloud server 50). Specifically, the busy flag F1 is switched to “ON” at the start of the cooperation process, and the busy flag F1 is switched to “OFF” at the end of the cooperation process. On the basis of the value of the busy flag F1, a check is made to determine whether the cooperation process among the three sides 10, 50, and 70 is being continued. In other words, a check is made to determine this matter (whether the cooperation process among the three sides 70, 50, and 10 is being performed), on the basis of the presence/absence of a session established between the audio device 70 and the cloud server 50 (specifically, an application for cooperation with an MFP 10).

However, the present invention is not limited to that.

For example, a check may be made to determine this matter (whether the cooperation process among the three sides 70, 50, and 10 is being performed), on the basis of information (such as flag information stored in the cloud server 50) indicating whether a job using the cloud server 50 is being executed. More specifically, a check may be made to determine whether the cooperation process among the three sides 10, 50, and 70 is being continued, on the basis of a flag (the flag F1 or some other flag F2) indicating whether a job is being executed. The flag F2 is switched to “ON” at the start of job acceptance (before or after step S15 (FIG. 10) or the like), and is switched to “OFF” at the end of job execution (before or after step S38 (FIG. 11) or the like), for example.

In each of the above embodiments, a period during which both an instruction from the cloud server 50 to the MFP 10 and an instruction to the operation panel 18 of the MFP 10 do not exist has been described as an example of a predetermined non-instruction period (a requisite for automatic reset generation). However. the present invention is not limited to that. For example, the predetermined non-instruction period may be a period during which only an instruction (such as a voice instruction) from the cloud server 50 to the MFP 10 does not exist. In other words, the elapse of the predetermined non-instruction period may be determined, regardless of the presence/absence of a user instruction to the operation panel 18 of the MFP 10.

Further, in each of the above embodiments, a mode in which the present invention is applied to a setting process relating to a copy job has been described as an example. However, the present invention is not limited to that, and may be applied to a setting process relating to some other job such as a scan job.

In each of the above embodiments, an MFP 10 has been described as an image processing apparatus, but the image processing apparatus is not limited to that. All image processing apparatus may be a copying machine, a print output apparatus (such as a single-function printer), or a scanner apparatus.

Further, in each of the above embodiments, an audio device 70 has been described as an example of an external device. However, the external device is not limited to that, and may be a tablet terminal or the like. Furthermore, a user instruction from the external device is not necessarily a voice instruction, but may be an operation instruction or the like generated by a user's finger. For example, the above idea can be applied even in a case where operation data based on an operation instruction issued through a tablet terminal or the like is transmitted to an MFP 10 via the cloud server 50. More specifically, the cloud server 50 stores settings information (settings information transmitted from a tablet terminal) based on a user instruction (an operation instruction) ⁻using the tablet terminal (an external device) into the settings database 310 or the like in the cloud server 50. The cloud server 50 also transmits the settings information to the MFP 10 during the cooperation process (if necessary). Particularly, after an automatic reset, a setting process in the MFP 10 is performed on the basis of the settings information stored in the cloud server 50 (the settings database 310), so that the user does not need to perform the setting again from the beginning.

Although embodiments of the present invention have been described and illustrated in detail, the disclosed embodiments are made for purposes of illustration and example only and not limitation. The scope of the present invention should be interpreted by terms of the appended claims.

What is claimed is:

1. An image processing system comprising an image processing apparatus and a cloud server, the image processing system being capable of performing a setting process in the image processing apparatus through a cooperation process among the image processing apparatus, the cloud server, and an external device,
wherein the cloud server includes:
an acquirer that acquires a user instruction relating to the setting process in the image processing apparatus from the external device;
a first storage that stores settings information about the image processing apparatus, the settings information being based on the user instruction;
a determiner that determines whether the cooperation process is being continued; and
a transmitter that transmits the settings information to the image processing apparatus,
the image processing apparatus includes:
a second storage that stores the settings information transmitted from the cloud server;
a setter that performs the setting process in the image processing apparatus, on a basis of the settings information; and
a resetter that resets the settings information stored in the second storage, in response to elapse of a predetermined non-instruction period, and,
when it is determined that the cooperation process is being continued after the settings information stored in the second storage is reset in response to elapse of the predetermined non-instruction period, the image processing system performs the setting process in the image processing apparatus, on a basis of the settings information stored in the first storage of the cloud server.

2. The image processing system according to claim 1,
wherein, when it is determined that the cooperation process is being continued, the transmitter of the cloud server transmits the settings information stored in the first storage to the image processing apparatus spontaneously or in response to a transmission request from the image processing apparatus, and,
after the settings information stored in the second storage is reset in response to elapse of the predetermined non-instruction period, the setter of the image processing apparatus performs the setting process in the image processing apparatus, on a basis of the settings information transmitted from the cloud server.

3. The image processing system according to claim 1,
wherein, when the user instruction is issued, the determiner determines whether the cooperation process is being continued,
the transmitter of the cloud server automatically transmits the settings information stored in the first storage to the image processing apparatus, in response to determination that the cooperation process is being continued, and
the setter of the image processing apparatus performs the setting process in the image processing apparatus, on a basis of the settings information transmitted from the cloud server.

4. The image processing system according to claim 3,
wherein, after the settings information stored in the second storage is reset in response to elapse of the predetermined non-instruction period, the setter of the image processing apparatus performs the setting process in the image processing apparatus, on a basis of the settings information transmitted from the cloud server.

5. The image processing system according to claim 3,
wherein, when a plurality of unit instructions for the external device is issued as the user instruction,
the settings information stored in the first storage is updated for each unit instruction, and
the transmitter sequentially transmits the settings information updated for each unit instruction, to the image processing apparatus for each unit instruction.

6. The image processing system according to claim 5,
wherein the image processing apparatus further includes
a display that displays settings contents on a basis of storage information about the second storage, and
the display displays settings contents based on the settings information updated for each unit instruction and transmitted from the cloud server for each unit instruction.

7. The image processing system according to claim 3,
wherein, after a plurality of unit instructions issued as the user instruction to the external device is executed, the transmitter collectively transmits the settings information stored in the first storage to the image processing apparatus, the settings information reflecting all the plurality of unit instructions.

8. The image processing system according to claim 3,
wherein, when it is determined that the cooperation process is being continued, the transmitter of the cloud server transmits the settings information stored in the first storage to the image processing apparatus, before elapse of the predetermined non-instruction period and after elapse of the predetermined non-instruction period.

9. The image processing system according to claim 1,
wherein the image processing apparatus further includes:
a communicator that inquires of the cloud server whether the cooperation process is being continued,
when response contents indicating that the cooperation process is being continued are received from the cloud server, the communicator transmits, to the cloud server, a request for transmission of the settings information stored in the first storage, and
the setter performs the setting process in the image processing apparatus, on a basis of the settings information transmitted from the cloud server in response to the request for transmission.

10. The image processing system according to claim 9,
wherein, after the settings information stored in the second storage is reset in response to elapse of the predetermined non-instruction period, the communicator inquires of the cloud server whether the cooperation process is being continued, and,
when response contents indicating that the cooperation process is being continued are received from the cloud server, the communicator transmits the request for transmission to the cloud server.

11. The image processing system according to claim 10,
wherein the image processing apparatus implements application software that performs the setting process in the image processing apparatus on a basis of the settings information transmitted from the cloud server, the application software being for cooperation between the cloud server and the image processing apparatus, and,
after the settings information stored in the second storage is reset in response to elapse of the predetermined non-instruction period, and the application software is temporarily terminated, the communicator of the image processing apparatus inquires of the cloud server whether the cooperation process is being continued, when the application software is restarted.

12. The image processing system according to claim 1,
wherein, when the user instruction is issued, the determiner determines whether the cooperation process is being continued,
the transmitter of the cloud server automatically transmits the settings information stored in the first storage to the image processing apparatus, in response to determination that the cooperation process is being continued,
after a first automatic reset has occurred to reset the settings information stored in the second storage in response to elapse of the predetermined non-instruction period, the setter of the image processing apparatus performs the setting process in the image processing apparatus, on a basis of the settings information transmitted from the cloud server,
the image processing apparatus further includes:
a display that displays settings contents in the setting process; and
a communicator that inquires of the cloud server whether the cooperation process is being continued in accordance with a user operation performed on the display after a second automatic reset has occurred to reset the settings information stored in the second storage in response to elapse of the predetermined non-instruction period and transmits, to the cloud server, a request for transmission of the settings information stored in the first storage after receiving, from the cloud server, response contents indicating that the cooperation process is being continued, the second automatic reset being different from the first automatic reset,
after the second automatic reset has occurred, the setter performs the setting process in the image processing apparatus, on a basis of the settings information transmitted from the cloud server in response to the request for transmission, and
the display displays settings contents based on the settings information transmitted from the cloud server in response to the request for transmission.

13. The image processing system according to claim 1,
wherein the cloud server further includes
a situation determiner that determines, through communication with the image processing apparatus, whether an automatic reset has occurred to reset the settings information stored in the second storage in response to elapse of the predetermined non-instruction period, and
when a plurality of unit instructions for the external device is issued as the user instruction,
in a situation where the automatic reset has not occurred, the transmitter transmits only difference information between information about a set value of a setting item changed in accordance with the plurality of unit instructions in a plurality of setting items, and information already transmitted to the image processing apparatus, and,
in a situation where the automatic reset has occurred, the transmitter collectively transmits the settings information that is information about set values of all the setting items in the plurality of setting items.

14. The image processing system according to claim 1,
wherein the cloud server further includes
a situation determiner that determines, through communication with the image processing apparatus, whether an automatic reset has occurred to reset the settings information stored in the second storage in response to elapse of the predetermined non-instruction period, and
when a plurality of unit instructions for the external device is issued as the user instruction,
in a situation where the automatic reset has not occurred, the transmitter transmits only difference information between information about a set value of a setting item changed in accordance with the plurality of unit instructions in a plurality of setting items, and information already transmitted to the image processing apparatus, and,
in a situation where the automatic reset has occurred, the transmitter collectively transmits the settings information that is information about a set value of a setting item changed in accordance with the plurality of unit instructions in the plurality of setting items.

15. The image processing system according to claim 1,
wherein the image processing apparatus further includes:
an operation panel capable of accepting a settings change operation from a user,
every time the user instruction is issued by a settings change operation on the operation panel, the transmitter of the image processing apparatus transmits information about a set value changed by the settings change operation to the cloud server, and
the first storage of the cloud server stores the settings information that is information including information about the set value changed through the operation panel.

16. The image processing system according to claim 1,
wherein the image processing apparatus further includes:
an operation panel capable of accepting a settings change operation from a user,
the operation panel accepts a plurality of settings change operations from the user,
every time the user instruction is issued by a settings change operation on the operation panel, the second storage of the image processing apparatus further stores information about each set value changed by the settings change operation,
immediately before the settings information stored in the second storage is reset in response to elapse of the predetermined non-instruction period, the transmitter of the image processing apparatus collectively transmits, to the cloud server, information updated with respect to each set value in accordance with the plurality of settings change operations, and
the first storage of the cloud server stores the settings information that is information including information updated with respect to each set value in accordance with the plurality of settings change operations.

17. The image processing system according to claim 1,
wherein the predetermined non-instruction period is a period during which an instruction from be cloud server to the image processing apparatus does not exist.

18. The image processing system according to claim 1,
wherein the predetermined non-instruction period is a period during which neither an instruction from the cloud server to the image processing apparatus nor an instruction to an operation panel of the image processing apparatus exists.

19. The image processing system according to claim 1,
wherein, when a plurality of unit instructions for the external device is issued as the user instruction before the predetermined non-instruction period has elapsed,
the first storage updates the settings information for each unit instruction.

20. The image processing system according to claim 1,
wherein the transmitter collectively transmits the settings information that is information about set values of all setting items in a plurality of setting items.

21. The image processing system according to claim 1,
wherein the transmitter collectively transmits information about a set value relating only to a setting item changed by the user instruction in a plurality of setting items.

22. The image processing system according to claim 1,
wherein the user instruction includes a voice instruction from a user.

23. A cloud server capable of cooperating with an image processing apparatus,
the cloud server comprising:
an acquirer that acquires a user instruction relating to a setting process in the image processing apparatus from an external device, during execution of the setting process in the image processing apparatus accompanied by a cooperation process among the image processing apparatus, the cloud server, and the external device,
a determiner that determines whether the cooperation process is being continued;
a first storage that stores settings information about the image processing apparatus, the settings information being based on the user instruction; and
a transmitter that transmits the settings information to the image processing apparatus,
wherein, after the settings information received from the cloud server and stored in a second storage of the image processing apparatus is reset in the image processing apparatus in response to elapse of a predetermined non-instruction period, when it is determined that the cooperation process is being continued, the transmitter transmits the settings information stored in the first storage to the image processing apparatus spontaneously or in response to a transmission request from the image processing apparatus, to cause the image processing apparatus to perform the setting process on a basis of the settings information stored in the first storage of the cloud server.

24. A non-transitory recording medium storing a computer readable program for causing a computer to perform a process, the computer being built in a cloud server capable of cooperating with an image processing apparatus,
the process including:
a) acquiring, from an external device, a user instruction relating to a setting process in the image processing apparatus, during execution of the setting process in the image processing apparatus through a cooperation process among the image processing apparatus, the cloud server, and the external device;
b) determining whether the cooperation process is being continued;
c) storing settings information relating to the image processing apparatus into a first storage of e cloud server, the settings information being based on the user instruction; and
d) transmitting the settings information to the image processing apparatus,
wherein the d) includes
d-1) after the settings information received from the cloud server and stored in a second storage of the image processing apparatus is reset in the image processing apparatus in response to elapse of a predetermined non-instruction period, when it is determined that the cooperation process is being continued, transmitting the settings information stored in the first storage spontaneously from the cloud server to the image processing apparatus, or transmitting the settings information from the cloud server to the image processing apparatus in response to a transmission request from the image processing apparatus, to cause the image processing apparatus to perform the setting process on a basis of the settings information stored in the first storage of the cloud server.
